(19) United States
(12) Patent Application Publication
(10) Pub. No.: US 2018/0088953 A1
(43) Pub. Date: Mar. 29, 2018

(54) A PROCESSOR SYSTEM AND METHOD BASED ON INSTRUCTION AND DATA PUSH

(71) Applicant: Shanghai Xinhao Micro Electronics Co. Ltd., Shanghai (CN)

(72) Inventor: Kenneth Chenghao LIN, Shanghai (CN)

(21) Appl. No.: 15/568,715

(22) PCT Filed: Apr. 22, 2016
(86) PCT No.: PCT/CN2016/080039

§ 371 Date: Oct. 23, 2017

(30) Foreign Application Priority Data
Apr. 23, 2015 (CN) 201510201436.1
May 6, 2015 (CN) 201510233007.2
May 20, 2015 (CN) 201510267964.7
Mar. 21, 2016 (CN) 201610188651.7

(51) Int. Cl. G06F 9/38; G06F 9/30; G06F 12/0875

(52) U.S. Cl. CPC G06F 9/3808; G06F 9/30058; G06F 2212/452; G06F 12/0875; G06F 9/3804

(57) ABSTRACT

The present invention provides a processor system and method. When applying to the processor and computer field, the serving cache can autonomously serve (push) instructions and data to the processor core, avoiding the delay of processor core fetching instruction and data from cache, and improves the computing performance.

### CROSS-REFERENCES TO RELATED APPLICATIONS

The application is the U.S. National Stage of International Patent Application No. PCT/CN2016/080039, filed on Apr. 22, 2016, which claims priority of Chinese Application No. 201510201436.1 filed on Apr. 23, 2015, and Chinese Application No. 201510233007.2 filed on May 6, 2015, and Chinese Application No. 201510267964.7 filed on May 20, 2015, and Chinese Application No. 201610188651.7 filed on Mar. 21, 2016, the entire contents of all of which are hereby incorporated by reference.

### FIELD OF THE INVENTION

This disclosure generally relates to computer, communication and integrated circuit.

### BACKGROUND

CPU of store program computer generates addresses and sends them to memory, fetching instructions and data from memory to CPU for execution, and sends back the execution results to memory for storage. The memory capacity increases as the technology advance, resulting in increasing memory access latency, and increasing memory access channel latency. However, the CPU execution speed increases as the technology advances, therefore, the memory access latency becomes the bottleneck of computer performance advancement. Therefore, store program computer employs cache to hide the memory access latency to ease this bottleneck. CPU accesses instructions or data from cache by the same method. The processor core in CPU generates addresses and sends them to cache, the cache returns the corresponding information to the processor core for execution, if the addresses match with the tags store in cache, and thus averts the memory access latency. The cache capacity increases as the technology advance, resulting in increasing cache access latency, and increasing cache access channel latency. However, the processor execution speed increases as the technology advances, therefore, the cache access latency becomes the worse bottleneck of computer performance advancement.

The afore method of processor core fetching information (including instruction and data) from memory for execution may be viewed as the process of processor core pulling information from memory. Pulling information has to endure the latency channel twice, once is the processor sending address to memory, the other is the memory sending information to the processor core. In addition, to support information pulling method, all store program computer or processor employs functioning blocks generating an keeping the addresses. Store program computer has instruction fetching pipeline stages in its pipeline. Modern store program computer uses employs a plural number of pipeline stages to fetch instructions, and thus deeper the pipeline and increases the penalty when branch prediction takes place. In addition, to generate and to keep a long instruction address consumes substantial energy. In particular, computer which converting the variable length instruction to a fix length micro-op is costly, as the computer may need to reverse convert the fix length micro-op address back to variable length instruction to index the cache.

The disclosed methods and systems are directed to solve one or more problems set forth above and other problems.

### BRIEF SUMMARY OF THE DISCLOSURE

This disclosure proposes a processor system comprised of a serving cache and a corresponding processor core; wherein the processor core does not generate and maintain an instruction address, nor does its pipeline contains an instruction fetching segment; The processor core only provides to the serving cache a branch decision, and a base address stored in the register file when an indirect branch instruction is executed. The serving cache extracts the control flow information in the stored instruction and stores it, and supplies (serves, pushes) the instruction to the processor core for execution according to the control flow information and the branch decision; The serving cache provides the correct indirect branch target instruction for execution to the processor core based on the base address from the processor core when an indirect branch instruction is encountered. Further, the serving cache may provide the processor core with the fall through instruction and the branch target instruction. The branch decision generated by the processor core chooses to execute one of the two instructions, and thus it is possible to mask the delay of the processor core to transfer the branch decision to the serving cache. Further, the serving cache may store the base address of the indirect branch instruction and the corresponding indirect branch destination address, so that it can reduce or eliminate the delay when pushing the indirect branch target instruction, thus partially or completely masking the delay of the base address transfer from the processor core to the serving cache. Further, the serving cache may forward instructions to the processor core in advance, based on the control flow information stored therein, thus partially or totally obscuring the delay of transmitting information from the serving cache to the processor core. The processor core of the processor system proposed by this disclosure does not need to have pipeline segment to fetch instructions, nor does it need to generate and record the instruction address.

This disclosure proposes a plural hierarchical organization, and the last (lowest) level cache (LLC) is a group associative organization with a virtual-physical address translation look-aside buffer TLB and a tag unit TAG. Virtual address is transformed into a physical address by TLB, and the resulting physical address of the memory is matched with the contents of the TAG to obtain the cache address of the LLC. Since the LLC cache address is mapped from the real memory address, the LLC cache address is actually a physical address. The resulting LLC cache address can be used to address the LLC's information memory RAM and can also be used to select the LLC Active list. The LLC active list stores the mapping between the LLC cache block and the cache block in the higher layer cache, that is, the LLC active list is addressed by the LLC cache address and its entry is the corresponding higher cache block address. In this disclosure, other caches other than LLC are all associative organizations, which are addressed directly at their own cache address, and do not require the tag unit TAG or TLB. The cache address of the present level is mapped with the higher-level cache address through the active list mapping. The active list is similar to the LLC active list, and is addressed by the cache address of this level and the higher-level cache address is stored in the entry. The highest-level cache has a corresponding track table (TT), which stores the control flow information extracted by the scanner from instructions stored in the highest-level cache memory RAM. The track table is addressed by the highest-level cache address, and its entry stores the branch target address of the branch instruction. The tracker (TR) generates the highest-level cache address addressing the first read port of the highest-level cache memory and output the fall-through instruction to the processor core; and the corresponding branch target address is also read out from the corresponding entry in the track table according to the highest-level cache address, and uses the said branch target address to address the second read port of the highest-level cache memory to output the branch target instruction to the processor core as well. The processor core executes the branch instruction to generate branch decision, selects one of the above two instructions and drops the other one. The said branch decision also controls the tracker to select one of the two branches correspondingly to address the highest-level cache to continuously push instructions to the processor core.

This disclosure proposes a cache replacement method that determines a cache block to be replaced according to the degree of association between cache blocks. The track table records the jump paths from the branch source to the branch target. This disclosure additionally uses the correlation table to record the corresponding lower-level cache address of the cache block, the jump paths of branch sources into the target cache block, and the number of branch sources jumping into the cache block. Defined the count of the branch source jumping in a cache block as the association degree of the cache block. A cache block with least degree of correlation, that is smallest the count, is the candidate to be replaced first. Between the cache blocks with the same degree of correlation, the oldest cache block is replaced first; to avoid the replacement of the cache block has just been replaced. When a cache block is replaced, use the jump paths (the branch source address) of this block stored in the correlation table to find the branch source entries in the track table, and replace each of the target address in the entries by the lower-level cache address stored in the correlation table. Therefore, this keeps the integrity of the control flow information stored in the track table. The above description is the replacement based on the degree of correlation within the same memory hierarchy level.

The minimum correlation degree replacement method can also be applied between different memory hierarchy levels. The method is to record the number of high hierarchy level cache blocks whose content are identical to a lower level cache block as the degree of correlation of the lower level cache block. The smaller the count, the less the degree of correlation. The lower level block with the least correlation is to be replaced. This method can be named the Least Children method, wherein Children means the higher-level cache blocks whose content is identical to the cache block. Also record the number of entries in the track table with the cache block as branch target (cache blocks and track tables can be at different memory hierarchy levels).When both counts are ‘0’, the cache block can be replaced. If the children count is not ‘0’, this cache block can be replaced after the replacement of its children. If the count of track table entries targeting a cache block as branch target is not ‘0’, this block can be replaced after the count changes to ‘0’, or can be replaced when each of the addresses of this cache block in all track table entries targeting this block is replaced by the lower-level cache address. The minimum degree of correlation between memory levels can also work together with the replace-the-oldest method described above.

This disclosure provides a method of temporarily storing the tracker and the register state in the processor core into memory identified by a thread number. The memory and the tracker and the register status of the processor core may be interchanged by threads in order to switch threads. Since the thread instructions in the serving cache of this disclosure are independent, there is no need to clear the cache when changing the thread, and there is no case where a thread executes an instruction of another thread.

This disclosure proposes a method and a processor system that can directly execute instructions provided by caches of a plurality levels of memory hierarchy.

This disclosure proposes a function call and function return method and system based on track table.

This disclosure provides a computer memory hierarchical organization method and system. With the exception of the hard disk, the memory hierarchy, including the traditional main memory, are organized as cache and are managed by hardware without memory allocation by operating system. This way of instruction or data reading does not need a matching the tag unit, thus reducing the read delay.

This disclosure proposes a fully associative cache method which preserves the bi-directional mapping relationship of data at different memory hierarchy levels, and avoids the tag address matching based on the bidirectional address mapping. Before executing a load instruction, the cache system serves the data to the processor core in advance according to the extracted and reserved stride information and interrelationships obtained when the same load instruction was executed before.

This disclosure proposes a method and system for extracting and recording the relationship (i.e., data address information contained in the data) between data organized in a logical manner. Based on the execution result of the load instruction, the method and the system learn, extract and reserve in the data track table, the logical relationship of data. The entries in the data track table correspondent-to-one to the data memory entries. The data track entry corresponding to the ‘data’ in the data memory preserves the ‘data type’ generated by the analysis of the relationship between the data. The data track table entry corresponding to the ‘address’ in the data memory preserves the after mapping ‘address pointer’ The ‘address pointer’ can directly address the data memory to read data without the need of matching by the tag unit. The method and system serve data to the processor core according to the interrelationships between the data before the logical relationship is extracted. After the logical relationship is extracted, the method and the system reads data and serves data to the core before the load instruction is executed, based on the logical relationship extracted the last time the same load instruction was executed and preserved in the data track table.

The memory hierarchy method and system of this disclosure autonomously serve most of the instructions and data to the processor core; in most cases, the processor core is only responsible for providing branch decisions or comparison results, and the processor's pipeline stop signal.

This disclosure provides a memory hierarchy and method that can access a memory hierarchy at the other end of a communication channel with a uniform memory address.

This disclosure provides a processor system comprise of a processor core and a cache, wherein the cache serves instructions and data to the processor core for the processor core to execute and process.

### BENEFITS OF THE INVENTION

The system and method of this disclosure may provide a basic solution for bi-directional delay of processor core accessing cache in a processor system. In a traditional processor system, the processor sends a memory address to the cache, which sends information (instructions or data) to the processor core according to the memory address. The system and method utilizing the correlation between instructions of this disclosure serve the instructions from the cache to the processor core, avoiding the delay of the processor to send the memory address to the cache. In addition, the serving cache of this disclosure is not a part of the processor core pipeline, so that the instructions can be served in advance to hide from the cache to processor core delay.

The system and method of this disclosure also provides a multilevel cache organization in which virtual-physical address translation and address mapping are carried out only at the lowest level cache (LLC). Rather than performing virtual-physical address translation at the highest-level cache, and performing address mapping at each level of cache as in the conventional cache, each of the cache level in the multi-level serving cache an be addressed by a cache address. The cache addresses are obtained based on memory physical address mapping such that the cost and power consumption of the fully associative cache is similar to the direct mapping cache.

The system and method of this disclosure also provides a cache replacement method based on the degree of correlation between data blocks. The method is suitable for cache based on the relation between instructions (control information flow).

Other advantages and applications of this disclosure will be apparent to those skilled in the art.

### BRIEF DESCRIPTION OF THE DRAWINGS

FIG. 1 is an exemplary embodiment of a track table based cache system according to this disclosure;

FIG. 2 is an exemplary embodiment of the processor system of this disclosure;

FIG. 3 is another exemplary embodiment of the processor system of this disclosure;

FIG. 4 is another exemplary embodiment of the processor system of this disclosure;

FIG. 5 is another embodiment of the processor system of this disclosure;

FIG. 6 is an address format of the processor system in the embodiment of FIG. 5;

FIG. 7 is part of memory table formats of the processor system of the embodiment of FIG. 5;

FIG. 8 is another exemplary embodiment of the processor system of this disclosure;

FIG. 9 is an exemplary embodiment of an indirect branch target address generator of the processor system of this disclosure;

FIG. 10 is the diagram of the pipeline structure of the processor core in the processor system of this disclosure;

FIG. 11 is another exemplary embodiment of the processor system of this disclosure;

FIG. 12 is an exemplary embodiment of the processor/memory system of this disclosure;

FIG. 13 is another exemplary embodiment of the processor/memory system of this disclosure;

FIG. 14 is a format for each stored table in the exemplary embodiment of FIG. 13;

FIG. 15 is an address format of the processor system in the exemplary embodiment of FIG. 13 of this disclosure;

FIG. 16 is a format of the data track table, the data active list, and a data correlation table according to this disclosure;

FIG. 17 is the stride table format and mechanism of this disclosure;

FIG. 18 is another exemplary embodiment of the processor/memory system of this disclosure;

FIG. 19 is a schematic diagram of the mechanism of the data cache hierarchy in the exemplary embodiment of FIG. 18 of this disclosure;

FIG. 20 is an improved exemplary embodiment of a data cache hierarchy in an embodiment of this disclosure;

FIG. 21 is an exemplary embodiment of perfecting data organized by a logical relationship;

FIG. 22 is an exemplary embodiment of a function call and a function return instruction;

FIG. 23 is a further exemplary embodiment of this disclosure for the processor system of this disclosure.

### DETAILED DESCRIPTION

The high-performance cache system and method proposed by this disclosure will be described in further detail below with reference to the accompanying figures and specific examples. The advantages and features of this disclosure will become more apparent from the following description and the claims. It is to be understood that the figures are in a very simplified form and are used in non-precise proportions only for the purpose of facilitating and clarifying the embodiments of the invention.

It is to be understood that, in order to clearly illustrate the contents of this disclosure, this disclosure contemplates a number of embodiments to further illustrate the different implementations of the invention, wherein the plurality of embodiments is enumerated but not exhaustive. In addition, for the sake of simplicity of explanation, the contents already mentioned in the preceding embodiment are often omitted in the latter embodiment, and therefore, the contents not mentioned in the following embodiments may be referred to the previous embodiments.

While the invention may be extended in various forms of modifications and substitutions, and some specific implementation diagrams are set forth in the specification and are illustrated in detail, it is to be understood that the starting point of the inventor does not limit the invention to the particular examples. On the contrary, the starting point of the inventor is to protect all improvements, equivalent conversions and modifications based on the spirit or scope defined by this claim. The same component numbers may be used for all drawings to represent the same or similar parts.

In addition, some embodiments have been simplified in the present specification in order to provide a clearer picture of the technical solution of this disclosure. It is to be understood that altering the structure, delay, clock cycle differences and internal connection of these embodiments within the framework of the technical solution of this disclosure is intended to be within the scope of the appended claims.

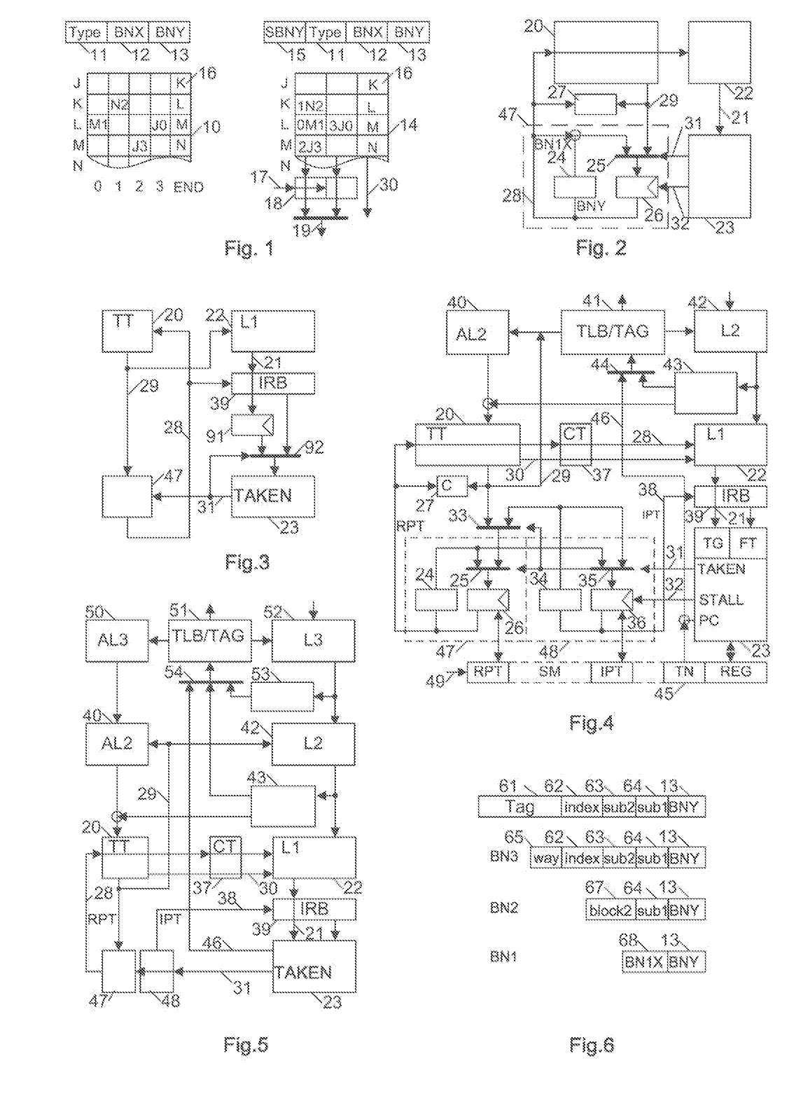

The cache in the processor system can be improved with a data structure called a track table (TT here after). The track table not only stores the branch target instruction information of branch instructions, but also stores the fall-through instruction information. FIG. 1 gives an exemplary embodiment of a cache system containing the track table described in this disclosure. Wherein 10 is an embodiment of the track table of this disclosure. The track table 10 consists of the same number of rows and columns as the L1 cache 22, where each row is a track corresponding to a L1 cache block in the L1 cache, and each entry on the track corresponds to an instruction of a L1 cache block. In this embodiment, it is assumed that L1 cache block in the L1 cache contains up to four instructions, whose block offset addresses BNY are 0, 1, 2, and 3, respectively. The following is a description of the five instruction blocks in the L1 cache 22, whose L1 cache block addresses BN1X are ‘J’, ‘K’, ‘L’, ‘M’, ‘N’, respectively. Therefore, there are corresponding 5 tracks in the track table 10, and up to 4 entries in each track correspond to up to 4 instructions in the L1 cache block of 24, and the entries in the track are also addressed by the BNY. In this embodiment, it can use the L1 cache address BN1, which consists of the L1 cache block address BN1X and the block offset address BNY, to address the track table 10 and the corresponding L1 cache 22, and read the track table entries and the corresponding instructions. The fields 11, 12, 13 in FIG. 1 are the entry formats of the track table 10. The entry format of the track table contains a specific field to store the program control flow information. The field 11 is the instruction type format, which can be non-branch instruction and branch instruction types based on the type of the corresponding instruction. The branch instruction type can be further divided into direct branch and indirect branch in one aspect, or be divided into conditional branch and non-conditional branch in another aspect. The field 12 stores cache block address, while the field 13 stores the cache block offset address. In FIG. 1, it uses the field 12 to be the L1 cache BN1X format and the field 13 to be the BNY format to illustrate. The cache address can also use other formats, at which time field 11 may add address format information to specify the address format in fields 12 and 13. The track table entry of a non-branch instruction only contains the instruction type field 11 which stores the non-branch instruction type, while the entry of branch instruction contains BNX field 12 and BNY field 13 other than instruction type field 11.

Only the fields 12 and 13 are shown in the track table 10 of FIG. 1. For example, the value ‘J3’ in the entry ‘M2’ indicates that the L1 cache address of the branch target instruction of the instruction corresponding to the ‘M2’ entry is ‘J3’. In this way, when the ‘M2’ entry in the track table 10 is read out according to the track table address (i.e., the L1cache address), it is determined that the corresponding instruction is a branch instruction according to the field 11 in the entry. The branch target of the instruction is the instruction of the ‘J3’ address in the L1 cache according to the fields 12 and 13. So that the instruction that BNY is ‘3’ in the ‘J’ instruction block in the L1 cache 24 found by addressing is the branch target instruction. In the track table 10, in addition to the columns of the above BNY of ‘0’ to ‘3’, an additional end column 16 is included, wherein each end entry has only fields 11 and 12, where field 11 stores an unconditional branch type and field 12 stores the BN1X of the fall-through instruction block of the instruction block corresponding to the corresponding row. According to the BN1X, the next instruction block can be found directly in the L1 cache and the track corresponding to the next instruction block can be found in the track table 10.

The blank entry in track table 10 shows the corresponding non-branch instruction, and the remaining entries correspond to the branch instruction, which also shows the L1 cache address (BN1) of the branch target (instruction) of its corresponding branch instruction. For a non-branch instruction entry on a track, the next instruction to be executed may only be the instruction represented by the entry on the right of the track. For the last entry on the track, the next instruction to be executed can only be the first valid instruction in the L1 cache block pointed by the content of the last entry on the track; For a branch instruction entry on a track, the next instruction to be executed can be an instruction represented by an entry on the right side of the entry, or an instruction pointed by the BN in its entry, which is selected by the branch decision. Thus, the track table 10 contains all the program control flow information for all the instructions stored in the L1 cache.

Refer to FIG. 2, which is an exemplary embodiment of the processor system of this disclosure. This embodiment contains the L1 cache 22, the processor core 23, the controller 27, the track table 20, which is the same as the track table 10 in FIG. 1. The Incrementor 24, the selector 25, the selector 25 and the register 26 compose a tracker 47 (inside the dashed line). The processor core 23 uses the branch decision 31 to control the selector 25 in the tracker, and uses the pipeline stop signal 32 to control the register 26 in the tracker. The selector 25, controlled by the controller 27 and the branch decision 31 to select the output 29 of the track table 20 or the output of the incrementor 24. The output of the selector 25 is registered by the register 26, and the output 28 of the register 26 is called a read pointer (RPT), and the instruction format is BN1. Note that the data width of the incrementor 24 is equal to the width of BNY and is only incremented by ‘1’ for the BNY in the read pointer without affecting the value of BN1X. If the incremental result overflows the width of BNY (that is, the capacity of the L1 cache block, such as when the carry output of the incrementor 24 is ‘1’), the system looks for the BN1X of the next L1 cache block in the end column to replace the BN1X of this block; the following embodiments are the same as this, and the explanation will be omitted. The tracker in the system of the present embodiment accesses the track table 20 via the bus 29 by the read pointer 28 to output the entry, and also accesses the L1 cache 22 to read the corresponding instruction for the processor core 23 to execute. The controller 27 decodes the field 11 in the entry output on the bus 29.If the instruction type in the field 11 is non-branched, the controller 27 controls the selector 25 to select the output of the incrementor 24, and the next clock cycle read pointer is incremented by ‘1’, and the fall through instruction is read from the L1 cache 22. If the instruction type in the field 11 is an unconditional direct branch, the controller 27 controls the selector 25 to select the fields 12, 13 on the bus 29, the next cycle read pointer 28 points to the branch target, reads the branch target instruction from the L1 cache 22. If the instruction type in the domain 11 is a direct conditional branch, the controller 27 lets the branch decision 31 to control the selector 25, and if it is determined that the branch is not executed, the next read pointer 28 is incremented by ‘1’ by the incrementor 24, and the fall through instruction is read from the L1 cache 22; if the decision is to ‘take the branch’, then in the next cycle the read pointer points to the branch target, and reads the branch target instruction from the L1 cache 22. When the pipeline is halted in the processor core 23, the update of the register 26 in the tracker is halted by the pipeline stop signal 32, causing the cache system to stop providing the processor core 23 with new instructions.

Returning to FIG. 1, the non-branch entry in track table 10 can be discarded to compress the track table. The entry format of the compressed track table adds the Source BNY (SBNY) field 15 in addition to the original fields 11, 12, 13 to record the offset address of the branch (source) instruction, for the compressed entry has a horizontal displacement in the table, it is no longer able to address it directly with BNY, although it still maintains the order between the branch entries. The compressed track table 14 preserves the same control flow information as in track table 10 in the compressed format. The compressed track table 14 only shows the SBNY field 15, the BNX field 12, and the BNY field 13. For example, the entry ‘1N2’ in the ‘K’ line indicates that the entry represents the instruction with the address K1, and its branch target is N2. The end entry 16 is in the rightmost column of the track table 14 and is output through the independent read port 30. When the read pointer 28 addresses the track table 14, use the BN1X portion of the 28 to read out all SBNY 15 values from the entries in the row corresponding to the BN1X, and each of the SBNY values is sent to the corresponding comparator in each column (the Comparator 18, etc.) and is compared with 17 (the BNY portion of the read pointer 28), respectively. Each of the comparator, outputs a ‘0’ if the SBNY value of the column is less than the BNY, but outputs an ‘1’ if otherwise. Check the output of these comparators and find the first ‘1’ from left to right. Use that ‘1’ to control the selector 19 to output the entry content in the row selected by the BN1X and in the column corresponding to that ‘1’ via bus 29. For example, when the addresses on the read pointer 28 are ‘M0’, ‘M1’, or ‘M2’ respectively, in all 3 cases the outputs of the left most comparators 18 is ‘1’, so that the content of the entry corresponding to the first ‘1’ output via bus 29 is ‘2J3’. When the embodiment of FIG. 2 uses the compressed track table format 14 as its track table 20, the controller 27 compares the BNY on the read pointer 28 with the SBNY on the track table output bus 29. If BNY is less than SBNY, it means the (branch) instruction corresponding to the track table entry read out by the read pointer 28 is still behind the instruction currently being read out from 22 by the same read pointer 28, thus the system continue the stepping. If the BNY is equal to SBNY, the track table entry read out by the read pointer 28 corresponds to the instruction being read out, thus the controller 27 control the selector 25 to perform the branch operation based on the branch type in the field 11 on 29. In the above embodiments of FIGS. 1 and 2, the cache system provides one instruction for each clock cycle as an example for illustration.

Refer to FIG. 3, which is another exemplary embodiment of the processor system of this disclosure. Wherein 20 is the track table of the L1 cache, 22 is the memory RAM of the L1 cache, 39 is the Instruction Read Buffer (IRB), 47 is the tracker, 91 is the register, 92 is the selector, and 23 Is the processor core. The IRB 39 may store a portion of a L1 instruction cache block or a single or a plurality of L1 instruction cache blocks. The tracker (TR) 47 produces the read pointer 28 which addresses the IRB 39 and the track table (TT) 20. The branch target address outputted by the TT goes to tracker 47 via the bus 29, and also addresses L1 memory RAM 22. The IRB 39 together with the L1 cache memory 22 constitutes a dual read port memory, the IRB 39 provides the first read port, the memory 22 provides the second read port, and the register 91 temporarily stores the second read port output data. The output of the IRB 39 and the output of the L1 cache RAM 22 are selected by the selector 92, under the control of the branch decision 31 output by the processor core 23. And the instruction selected by the selector 92 is sent to processor core 23 for execution.

The operation of the processor system of the embodiment of FIG. 3 will be described below with reference to the contents of the track table 14 in FIG. 1. All entries in the ending column 16 of 14 is unconditional direct branch type. For illustration, in all embodiments of the present disclosure, it is assumed that the other entries in 14 are all direct conditional branch types. At the beginning, the read pointer 28 points to the address ‘L0’, reads the corresponding instruction from the IRB 39, and the default value of the branch decision 31 controls the selector 92 to select the instruction from the IRB 39 for the processor core 23 to execute. At the same time, the address ‘L0’ on the read pointer 28 addresses the track table 14, outputs the entry ‘0M1’ via the bus 29; accesses the L1 cache 22 with the address ‘M1’ on 29, reads the corresponding branch target instruction to save in register 91. At this time, the controller 27 compares the SBNY field 15 on the bus 29 and the BNY field 13 on the read pointer 28 to find that the two are equal, so that the selector 92 is controlled by the branch decision 31. Assuming that 31 is ‘no branch’ at this time, then the 31 controls the selector 92 to select the output of the IRB 39 at the next clock cycle. In the next clock cycle, the read pointer 28 is stepped to point to the address ‘L1’, and the corresponding instruction is read from the IRB 39, and the instruction is selected by the selector 92 for the processor 23 to excute. At the same time, the address ‘L1’ on the read pointer 28 addresses the track table 14, outputting the entry ‘3J0’ via the bus 29; accesses the L1 cache 22 at address ‘J0’ on 29, reads the corresponding instruction as the branch target instruction to store in register 91. The controller 27 compares the SBNY field 15 on the bus 29 and the BNY field 13 on the read pointer 28 to find that the two are not equal, so 27 controls the selector 92 selecting the output of the IRB 39 for the processor core 23 to execute. In the next clock cycle, the controller 27 finds that the SBNY field 15 on the bus 29 and the BNY field 13 on the read pointer 28 are still not equal, so that the 27 still controls the selector 92 to select the output of the IRB 39 for the execution of the processor core 23. In the next cycle, the read pointer 28 steps to point to the address ‘L3’, then the controller 27 finds that the SBNY field 15 on the bus 29 and the BNY field 13 on the read pointer 28 are equal to each other, so that the selector 92 is controlled by the branch decision 31. Assuming that at this time 31 is ‘take the branch’, which controls the selector 92 to select the output of the register 91, i.e., the branch target instruction with the address ‘J0’, for the processor 23 to execute. At the same time, the branch decision 31 also controls the tracker 47 to select the ‘J0’ on the bus 27 and put it in the read pointer 28 to control the ‘J’ L1 cache block to be stored in the IRB 39. In the next cycle, the read pointer 28 is stepped to point to ‘J1’, and controls the IRB 39 to output the corresponding instruction, which is then selected by the selector 92 for execution by the processor core 23.

Refer to FIG. 4, which is another exemplary embodiment of the processor system of this disclosure. Wherein 40 is the Active List 2 (AL2 here after), 41 is the address translation look-aside buffer TLB and the tag unit TAG of the L2 cache, 42 is the memory RAM of the L2 cache, 43 is the scanner, 44 is the selector, 20 is the track table of the L1 cache, 37 is the correlation table of the L1 cache, 22 is the memory RAM of the L1 cache, 27 is the controller, 33 is the selector, 39 is the instruction read buffer (IRB). The incrementor 24, selector 25, and the register 26 compose the tracker 47. The incrementor 34, selector 35 and the register 36 compose the tracker 48. 23 is the processor core, which can receive two instructions and execute one of them under the control of the branch decision and drop the other one. 45 is the register to store the processor status of each process.

Scanner 43 scans the instruction blocks stored from the L2 cache memory 42 to the L1 cache memory 22, calculates the branch target address of the branch instructions directly. The method is adding the branch offset in the branch instruction onto the memory address of the branch instruction itself. The calculated branch target address is selected by selector 44 and is sent to TLB/tag unit 41 to match. The AL2 40 is accessed by using the matched L2 cache address BN2. If the instruction corresponding to the L2 cache address has already been stored in the L1 cache memory 22, then the corresponding entry in 40is valid, at this time the BN1X block address in that entry and the type of that branch instruction generated by the scanner 43 and the block offset BNY are combined into a track table entry. If the instruction corresponding to the L2 cache address has not been stored in the L1 cache memory 22, then the corresponding entry in 40is not valid, at this time the L2 cache address BN2 (including the block offset BNY) got by the matching above and the type of that branch instruction generated by the scanner 43 are combined into a track table entry. The so generated track table entries are written into a track in the track table 20 which corresponds to the said instruction block of memory 22, in the order of the instructions. Thus the extraction and storage of the program flow contained in the instruction block are completed.

The read pointer 28 generated by the tracker 47 addresses the track table 20 to read the entry and output it via bus 29. The controller 27 decodes the branch type and the address format of the output entry. If the branch type in the output entry is direct branch, and the cache address is BN2 format, the controller 27 addresses the AL2 40 with the BN2 address If the entry in 40 is valid, the BN1X in the entry is filled into the track table 20 to replace the BN2X in the entry so that it becomes the BN1 format; If the entry in 40 is invalid, it uses that BN2 to address the L2 cache memory 42, reads the instruction block to fill in one L1 cache block of the L1 cache memory 22 provided by a cache replacement logic, and fills the L1 cache block number BN1X in the invalid entry in 40 and sets it to valid, and fills that BN1X into the entry of the track table as above, and replaces that BN2 address with BN1 address. The BN1 address written into track table 20 above can be bypassed to bus 29 to the tracker 47 for use. If the branch type output by bus 29 is direct branch, and the cache address is BN1 format, the controller 27 makes it directly sent to the tracker 47 for backup.

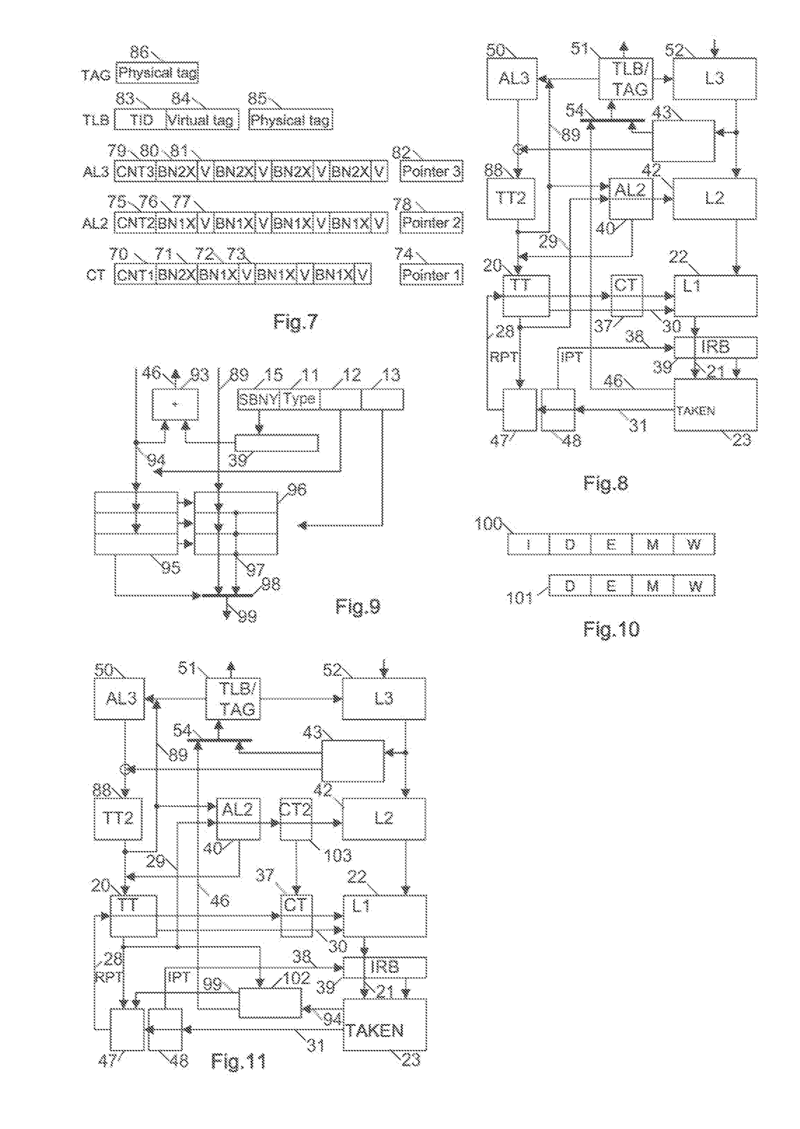

If the branch type output by bus 29 is indirect branch, the controller 27 controls the tracker to wait for the processor core 23 to calculate the indirect branch target address and send it by bus 46, 44 to L2 cache TLB/tag unit 41 to match. Use the matched L2 cache address BN2 to access the AL2 40. If the corresponding entry in 40 is invalid then use the BN2 address to address L2 cache memory 42 to read the instruction block to fill in a L1 cache block the L1 cache memory 22 as above, and bypass the obtained BN1 to the tracker 47 for backup. The correlation table 37 is a component of the replacement logic of L1 cache 22, and its structure and function will be described in FIG. 7.

There are two pipelines before the branch decision pipeline segment in the processor core 23, one of which receives the fall through instruction from the IRB 39, which is named the FT (Fall-through) branch; the other receives the branch target instruction from the L1 cache memory 22, which is named TG (Target) branch. The number of front-end pipeline segments included in the two branches is determined by the pipelined structure of the processor. In this embodiment, two front-end pipeline segments are included as examples. The branch decision pipeline segment in the processor core 23 executes the branch instruction, and one of the two instructions is selected to be executed according to the generated branch decision 31, and the other branch is discarded. In the present embodiment, the IRB 39 can store two instruction blocks as an example, and the IRB 39 is addressed by the IPT read pointer 38 of the tracker 48. The L1 instruction cache 22, the correlation table 37, and the track table 20 are addressed by the RPT 28 of the tracker 47.

When the processor core 23 does not have a decision on the branch, the default value of the branch decision 31 is ‘0’, i.e., do not execute branch, the processor core 23 selects to execute the instruction of the FT branch; when the processor core 23 generates a decision on the branch, if it is decided as ‘do not execute branch’, the value of the branch decision 31 is ‘0’, and the processor core 23 selects to execute the instruction of the FT branch; when the processor core 23 generates a decision on the branch, if it is decided as ‘execute branch’, the value of the branch decision 31 is ‘1’, and the processor core 23 selects to execute the instruction of the TG branch. The selector 33, 25, 35 can be controlled by the branch decision 31, and when 31 is ‘0’, the three selectors select the input on the right; when 31 is ‘1’, the three selectors select input on the left. In addition, the selector 33 and 25 are also controlled by the controller 27 when the processor core 23 does not make a decision on the branch. The operation of the processor system of the embodiment of FIG. 4 will be described below in connection with the contents of the track table 14 in FIG. 1. At the beginning, the M instruction block has been in the IRB 39, the branch decision 31 is ‘1’, the selectors 25 and 35 both select the input on the left, and the IPT read pointer 38 and the PT read pointer 28 all point to the address M1. The M1 instruction in the IRB 39 pointed to in the IPT 38 is served into the FT branch front line in the processor core. At the same time, the RPT 28 points to the track table 20 and reads out the value of the end entry 16 of the M row from the independent that is ‘N’, in order to address the L1 cache 22 to output the N instruction block to store into the IRB 39. And then outputs the entry 2J3 in the track table 14 in the M line matching the BNY address ‘1’ via the bus 29. At this time, the instruction branch decision 31 is the default value ‘0’, the selector 35 selects the input of the incrementor 34, the IPT pointer 38 is stepped, and control the IRB 39 to output M2, M3, N0 instructions to the FT branch front end of the processor core 23. The controller 27 compares the value ‘2’ on the field 15 SBNY on the bus 29 with the value ‘1’ of the field 13 BNY on the RPT 28 and controls the selector 25 to select the output of the incrementor 24 when they are not equal, and the RPT 28 is stepped to point to M2. At this time, the SBNY on the bus 19 is equal to the BNY on the RPT read pointer 28, the decoder 27 controls the selector 33 and the selector 25 to select the input on the right, i.e., the BN1 address J3 on the bus 29 is stored in the register 26. Thereafter, the controller 27 controls the RPT read pointer 28 to read J3, K0 instructions from the L1 cache 22 to the TG branch front pipeline of the processor core 23.

M2 is a branch instruction which, when it reaches the pipeline segment of the processor core 23 for branch decision, that pipeline segment executes the M2 instruction to generate a branch decision. If the branch decision ‘31’ is ‘0’, then the processor core 23 selects the M3 and N0 instructions in the FT branch to continue executing, and the J3, K0 instruction in the TG branch is discarded. The branch decision 31 controls the selectors 25 and 35 to select the output of the incrementor 34 to store into the registers 26 and 36 so that both the RPT 28 and the IPT 38 point to N1, the IPT 38 controls the IRB 39 output N1 and the subsequent instructions to the FT branch of the processor core 23 for continuing execution. At this time, the RPT 28 points to the N row in the track table, reads the end entry of the N row, and sends it to the L1 cache 22 to read fall through instruction block of the N instruction block to store in the IRB 39.

If the branch decision ‘31’ is ‘1’, then the processor core selects the J3 and K0 instructions in the TG branch to continue execution, and the M3 and N0 instructions in the FG branch are discarded. At this time, the branch decision 31 controls to store the K row instructions outputted by the L1 cache 22 into the IRB 39 and controls the selectors 25 and 35 to select the output of the incrementor 24 and store it into the registers 26 and 36, and controls both the RPT 28 and the IPT 38 to point to K1. IPT 38 controls IRB 39 to output K1 and subsequent instructions to FT branch of the processor core 23 for continuous execution. RPT 28 points to the K line, and the end entry of the K line is sent to the L1 cache 22 to read the L line and stored in the IRB 39. In this way, the processor 23 can execute instructions without interruption, and without the pipeline pause due to branching.

The tracks in the track table are orthogonal to each other, so they can coexist and do not affect each other. The indirect branch address 46 generated by the processor core in FIG. 4 is a virtual address, which is selected by the selector 44 after combined with the thread number, where the index address is simultaneously sent to the TLB and the L2 tag unit in 41, where the virtual tag part is along with the thread number are sent to the TLB to map into physics tag. The physics tag is used to match with the tags read from each way in L2 tag unit according to the index address. The obtained way number and the index in the virtual address are combined into an L2 cache address, so the L2 cache address BN2 and the L1 cache address BN1 which is mapped by it are actually mapped by the physical address rather than by the virtual address mapping. So that for the two different threads of the same virtual address in the processor, their cache addresses BN are actually different, avoiding the same virtual address of different threads of different programs addressing the same address (address aliasing) problem. On the other hand, for the same virtual address of the same program of different threads, because it is mapped to the same physical address, the mapping of the cache address is the same, avoiding duplication problem of the same program in the cache. Based on this feature of the cache address, it can achieve multi-thread operation. 45 in FIG. 4 is a register group in which the thread number and the status register in the processor according to the thread, such as the contents of the register 26 in the tracker 47 and the register 36 in the tracker 48, and each register value of that thread in the processor core 23of FIG. 4. 45 is addressed by thread number 49. When the processor is to switch the thread, the values in the register 26 and the register 36 in tracker 47 and 48 and the registers in the processor core 23 are all read out and stored into the entry pointed to by the switched-out thread number on bus 49. Then the switched-in thread number is sent via bus 49 to 45, filling the registers 26, 36 and the registers in the processor core 23 with the contents of the 45 entry designated by the thread number, and then the IRB 39 is filled with the instruction block pointed to by the IPT 38 and its next instruction block, then it can start the operation of the switched-in thread. The instructions in each of the threads in the track table 20 and in the caches 42 and 22 are orthogonal, and there is not possible that a thread erroneously executes another thread's instruction.

Refer to FIG. 5, which is another exemplary embodiment of the processor system of this disclosure. The AL2 40, the L2 cache memory RAM 42, the L2 scanner 43, the track table 20, the correlation table of the L1 cache 37, the L1 cache memory RAM 22, the IRB 39, the tracker 47, the tracker 48 and the processor core 23 have the same function as the modules of the same number in the embodiment of FIG. 4; although the controller 27 and the selector 33 are omitted for ease of reading in FIG. 5, the operation under the L2 cache is the same as the embodiment of FIG. 4. In FIG. 5, a L3 cache is added, consisting of a level 3 active list (AL3) 50, a TLB and a tag unit TAG 51 for L3 cache, a L3 cache memory 52, a L3 scanner 53, and a selector 54, instead of the TLB and tag unit 41 of L2 cache, and the selector 44. In FIG. 5, the last level cache, the L3 cache 52, is way set associative, and the L2 cache 42 and the L1 cache 22 are all fully associative. Wherein each of the L2 cache blocks in L2 cache 42 contains four L1 cache blocks, and L3 cache block in each way of the L3 cache 52 contains four L2 cache blocks.

FIG. 6 is the address format of the processor system in the embodiment of FIG. 5. The memory address is divided into a tag 61, an index 62, a second sub-address (L2 sub-address) 63, a first sub address (L1 sub-address) 64, and an intra-block offset (BNY) 13. The L3 cache address BN3 is composed of the way number 65, the index 62, the L2 sub-address 63, the L1 sub-address 64, and the intra-block offset (BNY) 13; wherein the way number 65 combines the index 62 to be the L3 cache block address; 65, 62, 63 combines to address a L2 instruction block in the L3 cache block; and the address combining all fields except block offset 13 is referred to as BN3X, which can address one L1 instruction block in the L3 cache block. The address BN2 of the L2 cache consists of a L2 cache block number 67 and a L1 sub-address 64, and an intra-block offset (BNY) 13; wherein the L2 block number 67 addresses a L2 cache block; all fields except the intra-offset 13 are collectively referred to as BN2X, which addresses an L1 instruction block in the L2 cache block. The address BN1 of the L1 cache consists of a L1 cache block number 68 (BN1X) and an intra-block offset (BNY) 13. The intra-block offset (BNY) 13 in the above-described four address formats is the same, and the BNY portion does not change when the address conversion is performed. In the BN2 address format, the L2 block number 67 points to a L2 cache block, and the L1 sub-address 64 points to one of the four L1 instruction blocks in the L2 cache block. Similarly, in the BN3 address format, the way number 65 and the index 62 point to a L3 cache block, the L2 sub-address 63 points to one of the four L2 instruction blocks, the L1 sub-address 64 points to one of the 4 L1 instruction blocks in the selected L2 instruction block.

FIG. 7 is part of memory table formats of the processor system of the embodiment of FIG. 5. The following description will be made with reference to FIGS. 5, 6 and 7. In FIG. 5, the format of the tag unit in 51 is the physics tag 86. The CAM format of TLB in 51 is the thread number 83 and the virtual label 84, and the RAM format is the physical label 85. The selector 83 selects the output thread number 83 and the virtual tag 84 to be mapped into the physical tag 85 in the TLB; the index address 62 in the virtual address reads the physical tag 86 to match with 85 to obtain the way number 65. The way number 65 and the index address 62 in the virtual address are combined to form a L3 cache block address.

The level 3 active list (AL3 here after) 50 in FIG. 5 is way set associated, in which each way contains the same number of rows as the L3 cache and the tag unit in 51, and is also addressed by the index address 62. There are count fields 79 and 4 BN2X fields 80 in each row, and the plural 80 in the same row is addressed by the level 2 sub-address 63. Each field 80 has its corresponding valid bit 81. Each same line shares a L3 pointer 82. The AL2 40 is fully associative and contains the same number of rows as the L2 cache RAM 42, and is addressed by the L2 block address 67. There are count field 75 and 4 BN1X field 76 in each row, and 76 is addressed by level 1 sub-address 64. Each of the 76 fields has its corresponding valid bit 77. Each line shares an L2 pointer 78. The correlation table (CT here after) 37 is organized in a fully associative manner and contains the same number of rows as the L1 cache 22, which is addressed by the L1 block address 68. There are count field 70, BN2X field 71, and several BN1X fields 72 in each row. Each field 72 has its corresponding valid bit 77. Each line shares a L1 pointer 74.

When a L2 instruction block in a L3 cache block in the L3 cache 52 is stored in a L2 cache block in the L2 cache 42, the block number of the L2 cache block in the 42 is stored in the entry 80 addressed by L2 sub-address 63 in the row of AL3 50 corresponding to that L3 cache block, and its corresponding valid bit 81 is also set to ‘1’ (valid). The instructions in the L2 cache block is decoded by the L3 scanner 53, wherein the branch offset in the branch instruction is added to the address of the instruction to obtain the branch target address. The address of the next L2 cache block of this L2 cache block is also determined by adding the memory address of this L2 cache block with the size of a L2 cache block. The branch target address or the fall through L2 cache block address is selected by the selector 54 to be matched in the tag unit 51, and if not matched, the address is sent to the lower layer memory to read instructions and the instructions are stored in the L3 cache memory 52. This ensures that for the instructions in the L2 cache memory 42, their branch targets, and the fall through cache blocks are at least in the L3 cache memory 52 or are in the process of being stored into 52.

When a L1 instruction block in an L2 cache block in the L2 cache 42 is stored in a L1 cache block in the L1 cache 22, the block number of the L1 cache block in the 22 is stored in the entry 76 addressed by L1 sub-address 64 in the row of AL2 40 corresponding to that L2 cache block, and its corresponding valid bit 77 is also set to ‘1’ (valid). The instructions in the L1 cache block is decoded by the L2 scanner 43, wherein the branch offset in the branch instruction is added to the address of the instruction to obtain the branch target address. The address of the next L1 cache block of this L1 cache block is also determined by adding the memory address of this L1 cache block with the size of a L1 cache block. The branch target address or the fall through L2 cache block address is selected by the selector 54 to be matched in the tag unit 51, and if not matched, the address is sent to the lower layer memory to read instructions and the instructions are stored in the L3 cache memory 52; if it is matched, then use the 65, 62, 64 parts of the obtained L3 cache address to read the entries 80 and 81 in the AL3 50. If 81 is ‘0’ (invalid), then use the 65, 62, 63, 64 parts of the obtained L3 cache address to address the L3 cache memory 52, reading an L2 cache block to store in an L2 cache block in the L2 cache memory 42, and write the block number 67 of this L2 cache block and the valid bit ‘1’ into the entries 80 and 81 addressed by the L3 cache address in AL3 50.

If the read-out entry 81 is ‘1’ (valid), then using the BN2X values (67 and 64) of the read-out entry 80 to address the AL2 (level 2 active list) 40 to read out entry 76 and 77. If 77 is ‘0’ (invalid), then combine the BN2X value and BNY to be the BN2 address (67, 64, 13) to store in entry corresponding to the said instruction in the track that is being filled in the track table 20. If 76 is ‘1’ (valid), then combine the BN1X value and BNY to be the BN1 address (68, 13) to store in entry corresponding to the said instruction in the track that is being filled in the track table 20. In addition, the branch type 11 decoded by the L2 scanner 43 is also stored in the entry of the track table 20 together with the BN2 or BN1 address. The next block address is matched and addressed in the above-described manner. If the next L2 instruction block is not yet in the L2 cache memory, the instruction block is stored from the L3 cache 52 to L2 cache 42; and the resulting BN2 or BN1 address is stored in the rightmost end entry 16 of the above track. This ensures that for the instructions in the L1 cache memory 42, their branch targets, and the fall through L1 cache blocks are at least already in the L2 cache memory 42 or are in the process of being stored into 42.

The present embodiment discloses a hierarchical pre-fetch function. Each level can ensure that the branch target in this level at least exist, or is being written into a lower level of memory hierarchy. This causes the branch target instructions of the instruction that the processor core is executing in most cases are in the L1 cache or L2 cache, masking the access delay to the lower memory levels.

The corresponding row in the CT 37 is established while the above-mentioned L1 instruction block is filled in the L1 cache memory 22 and the instructions in the cache block are scanned to establish the corresponding track to fill in the track table 20. The BN2X addresses (67 and 64) of the L1 cache block are filled in the field 71 of the corresponding row in CT 37 so that when the L1 cache block is replaced, the BN2X address can replace the L1 cache block number BN1X in entries that targeting that L1 cache block, in order to keep the Integrity of the control flow information in the track table. At the same time, use the BN1X in the branch target in the track being written in the track table 20 to address the row in the CT 37, and increase ‘1’ to the count value 70 in that row, in order to record another branch instruction that uses that row to be the target, and write the L1 cache block number of the track itself into its 72 field, and set the corresponding field 73 to ‘1’ (valid) to record the path of the branch source (address). For the next sequential L1 cache address that is stored in the track end entry, the row in the associated table 37 is also addressed in a similar manner.

The branch target address format in the entry of track table 20 can be BN2 format or BN1 format. When the track table entry is output from the bus 29, the controller (27 of FIG. 4) decodes the branch type 11 of it. If its address format is BN2, then the controller use the BN2X address (67 and 64) on bus 29 to address AL2 40 to read the entries 76 and 77. If 77 is ‘0’ (invalid), then use that BN2X address to address the L2 cache memory 42 to read out an L1 instruction block to store into an L1 cache block in the L1 cache memory 22, and store that L1 cache block number and the valid value ‘1’ into the entries 76 and 77 pointed to by the BN2X address above in the AL2 40. If 77 is ‘1’ (valid), then use the BN1X 68 of 76 to write the entry 12 in the track table while not changing the BNY of the entry 13; the process of the tracker 48 addressing IRB 39 to provide continuous instructions for the processor core 23 is the same as FIG. 4, and is omitted here.

The Cache Replacement Logic of this embodiment is to use the combination of the Least Correlation (LC) and the Earliest Replacement (ER) (hereinafter referred to as LCER) to determine the cache block that can be replaced. The count 70 in the CT 37 can be used to check the correlation. The smaller the count value, the less number of cache blocks that target the L1 cache block, and the L1 cache block is easier to be replaced. The pointer 74 shared by all rows in the CT 37 points to the row that can be replaced (The count 70 of the replaceable row must be lower than a preset value). When the L1 cache block pointed to by the pointer 74 is replaced, the corresponding track in the track table 20 pointed to by the 74 is also replaced by the new track containing branch types and branch targets exacted from the replacing (new) L1 cache block by the L2 scanner 43. And in the CT 37 entry pointed out by pointer 74, each field 72 with a valid field 73 points to a track in the track table 20. Replacing the branch target addresses of the BN1X address of the cache block being replaced in those tracks by the BN2X address stored in the 71 field of the CT 37 entry pointed by the pointer 74. So each instruction targeting the replaced (old) L1 cache block is now targeting the same instruction stored in the L2 cache memory 22 as a branch target. This ensures the replacement of the L1 cache block does not impact the integrity of the control flow information. At the same time, it also uses that BN2X to address the AL2, increases the count number 75 in the entry of 40 according to the number of times of replacing BN1X with BN2X in the track table 20 described above, in order to record the increased correlation of the L2 cache block; and set the valid bit 77 of the entry of 40 corresponding to the replaced L1 cache block (pointed to by the field 64 of the BN2X address) to be ‘0’ (invalid). After which the pointer 74 moves in a single direction and stays on the next row that satisfies the least correlation; when the pointer goes out of the boundary of all the rows in the CT 37, it wraps back to another boundary (e.g., if it exceed the largest address row then it begins the least correlation checking from the least address row). The one-way movement of the pointer 74 ensures that the L1 cache block which was previous replaced earliest (oldest block) can be the first candidate of replacement, which is what ER above means. The detection of the count number 75 of each row and the one-way movement of the pointer 74 implement the LCER L1 cache replacement strategy. This replacement method replaces a singular L1 cache block at a time.

It can also replace in-order or in reverse-order following the program order. For example, when a L1 cache block is replaced, the cache block pointed to by the L1 cache block number (BN1X) in the end entry of its track is also replaced, which method is called in-order replacement. Or when a L1 cache block is replaced, its previous block in program sequence is also replaced. This is called reverse-order replacement. The previous block is designated by the BN1X in a field 72 of the corresponding CT row of the L1 cache block. Or it can even begin from an L1 cache block in both in-order and reverse-order to replace. It can continuously replace in-order or reverse-order until it encounters a L1 cache block, which corresponding count number 70 in the corresponding table 37 exceeds the preset value. This replacement method replaces a plurality of L1 cache blocks at a time. The singular replacement method or the plural replacement method may be used as desired. Different methods can also be used in combination. For example, in normal cases use the singular replacement method, and when the low-level cache lacks replaceable cache blocks use the plural replacement method.

The replacement of the L2 cache is also based on the LCER strategy. In addition to the operation that setting the corresponding field 77 in the AL2 40 to ‘0’ and increase the count number 75 when the L1 cache block is replaced; when the cache block is stored from L2 cache memory 42 into L1 cache memory 22, the corresponding valid bit 77 in the corresponding entry in AL2 40 is set to ‘1’, and the L1 cache block number (BN1X) is written to the corresponding field 76. Each time when the BN2X obtained by matching the branch target address is stored into track table 20, the count number 75 in the AL2 corresponding to that BN2X is increased by ‘1’; each time when the BN2X in the track table entry is replaced by BN1X, the count number 75 in the AL2 corresponding to that BN2X is decreased by ‘1’. In this case, the count number 75 records the number of times that an L2 cache blocks to be used as branch target; and each valid bits 77 in the entry records whether a portion of the L2 cache block has been stored in the L1 cache; each 76 field records the block address 68 of each corresponding L1 cache block. The L2 cache replacement makes the L2 pointer 78, which is shared by all L2 cache blocks, to move in one-direction and stay on the next replaceable L2 cache block. The replaceable L2 cache block can be defined as whose count value 75 and all of its 77 fields of the corresponding AL2 40 entry are ‘0’. That is, a L2 cache block is replaceable when none of the instructions in the L1 cache 22 is a part of the L2 cache block. And the moving pointer 78 moving in one-direction assures the ER afore described.

The replacement of the L3 cache is also based on the LCER strategy. When the cache block is stored in the L2 cache memory 42 from the L3 cache memory 52, the corresponding valid bit 81 in the corresponding entry in the AL3 50 is set to ‘1’, the L2 cache block number BN2X is written to the corresponding field 80. The count number 79 in the entry of the AL3 50 is not used in the present embodiment. The L3 cache is a set-associative organization, in which each set (with same index address) has a plurality of ways, and each way in the same set uses a common shared pointer 82. It is also possible to find the next replaceable way by the pointer 82, where the replaceable way can be the way whose all fields 81 are ‘0’. That is, the L3 cache block correlate to none of the instructions in the L2 cache 42 and can therefore be replaced. Other method as well as the one-direction moving pointer can be used to ensure the recently replaced L3 block is not replaced soon.

In the present embodiment, the L3 cache is a set-associative organization. If it encounters a set that each of its way is not replaceable (each way in the AL3 50 has at least one field 81 being ‘1’), it then selects the L1 cache block which contains the least field 81 being ‘1’ to do the plural replacement. If a way contains only one field 81 of value ‘1’, that is, only one of the four L2 instruction blocks that can be stored in the L3 cache block is in the L2 cache memory 42, so that the BN2X in the field 80 corresponding to that field 81can be output to address the AL2 40, and use it to read the BN1X number in the first valid field 76 (whose 77 field is ‘1’), and calculate out there are N L1 cache blocks from this L1 cache block to the last valid L1 cache block in the L2 cache block. The BN1X and the number of L1 cache blocks N is sent to the L1 cache replacement logic, and N L1 cache blocks are replaced from the L1 cache block pointed to by the BN1X, and the cache blocks that use these cache blocks as target are together replaced, and then the L2 cache block can be replaced. Then all the fields 81 in the above-mentioned way-set in the AL3 50 are ‘0’, and the corresponding L3 cache block can be replaced. If the L1 cache blocks contained in the L3 cache block is not continuous, then according to the above method to set plural starting points and plural corresponding N values to send to the L1 cache replacement logic to replace in order.

In the embodiment of FIG. 7, the count number in each level, such as the 79 in AL3 50, the 75 in AL2 40, and the 70 in the level 1 correlation table (CT1) 37 are used to record the degree of correlation of the cache blocks in the same memory level. The valid bits in each level which has a higher memory level are used to record the degree of correlation of the cache blocks in the higher memory level, such as the 81 in AL3 50 records the correlation degree with L2 cache blocks, the 77 in AL2 40 records the correlation degree with L1 cache blocks. The 73 of the CT 37 records the branch source address that targets the L1 cache block. So that it is feasible to use the BN2X address 71 in CT 37 corresponding to the cache block to replace the BN1X address of this cache block in each entry of track table 20 designated by the said recorded branch source address, to preserve the integrity of the control flow information in the track table. In this way, this cache block can be safely replaced. The alternative replacement method can select the cache block with the correlation degree of ‘0’. In essence, the cache system of this disclosure operates based on control flow information, so that the basic principle of cache replacement is without compromising the integrity of the control flow information.

Refer to FIG. 8, which is another exemplary embodiment of the processor system of this disclosure. FIG. 8 is an improvement of the embodiment of FIG. 5, in which the AL3 50, the TLB and the tag unit 51 of the L3 cache, the L3 cache memory 52, the selector 54, the AL2 40, the L2 cache memory 42, the track table 20, the CT 37 of L1 cache, the L1 cache memory 22, the IRB 39, the tracker 47, the tracker 48, and the processor core 23 have the same functions as the modules in the embodiment of FIG. 4 with same numbers. Wherein the L2 scanner 43 (which can generate a branch type) is connected to the bus from the L3 cache 52 to the L2 cache 42, and there is only one scanner in this embodiment. In addition, an L2 track table 88 is added. The arrangement of the caches in the embodiment of FIG. 8 is the same as that in the embodiment of FIG. 5.

Each track in the L2 track table 88 corresponds to a L2 cache block in the L2 cache 42. Each L2 track contains four L1 tracks, each of which corresponds to a level 1 instruction block in the L2 cache block. The track entries of the L1 tracks in the L2 track table 88 are also in the formats of SBNY 15, type 11, BNX 12 and BNY 13 in FIG. 1, and the address format can be in either BN3 or BN2 format. The scanner 43 performs a scan of the L2 cache blocks stored from the L3 cache memory 52 to the L2 cache memory 42, and calculates the branch target addresses for the branch instructions therein. The branch target address is selected by the selector 54 to be sent to the TLB/tag unit 51 to match into the BN3 address, and the BN3 address is used to address the AL3 50 to detect whether the entry is valid (whether the corresponding cache block has been stored in the L2 cache memory 42); if valid, the BN2X address in the entry and the BNY address in the BN3 address are combined into the BN2 address, and the BN2 address, together with the SBNY 15 and the type 11 generated by the scanner, is stored in the entry of AL2 88 corresponding to that branch instruction; if it is invalid, then directly store the BN3 address together with the SBNY 15 and type 11 in the entry of 88.

When a level 1 instruction block in the L2 cache block of the L2 cache memory 42 is stored into a L1 cache block in the L1 cache memory 22, the L2 track table 88 outputs the corresponding L1 track via the bus 89 to store into the track table 20. If the address in the entry on the track is in the BN3 address format, then use that address to access the AL3 50, and if the AL3 entry bit 81 is invalid, then according to the above method store the L2 cache block from the L3 cache 52 into an L2 cache block in the L2 cache 42, and combine the L2 cache block number and the L2 sub-address 64 within the BN3 address into a BN2X address, then store that BN2X address into the field 80 of the AL3. If the AL3 entry is valid, then store the BN2X in the entry into the L2 track table 88 to replace the original BN3X address. The BN2X is also bypassed to bus 89 to store into track table 20. The present embodiment uses the count number 79 in the AL3 50. Similar to the use of the count number 75 in the AL2 in the embodiment of FIG. 6, when the BN3 address is written into the L2 track table 88, the count number 79 in the corresponding AL3 50 is increased, and when the BN3 address output from the L2 track table 88 is mapped to the BN2 address in the AL3 50, the corresponding count number 79 is decreased. The L3 cache replacement not only checks the values of each valid bit 81, but also checks the count number 79.

The BN2 address on bus 89 is also used to address the AL2 40, if the valid bit 77 of the entry in 40 is invalid, then the BN2 address is stored in the entry of track table 20; if the valid bit 77 of the entry in 40 is valid, then combine the BN1X address of the entry of 40 and the BNY address of the BN2 address to store into the entry of track table 20. When the BN2 address is output from the track table 20 via the bus 29, it is used to address the AL2 40, and if the valid bit 77 in the entry is invalid, then use that BN2 address to access the L2 cache memory 42 to read an L1 cache block and store it into an L1 cache block in the L1 cache memory 22, and that L1 cache block number BN1X is stored in the field 76 of the AL2 40, and the BN1X is stored in the track table 20, the BN1X can also be bypassed to bus 29 for use by the tracker 47. The address of the track entry in the AL2 88 in this embodiment can be in the BN3 or BN2 format. The address of the track entry in the active list 20 may be in the BN2 or BN1 format. Another strategy is to fill in the track table 20 with BN1 address only, when the address on the bus 89 is of BN2 format, use it to address an AL2 40 entry. If the bit 77 of the entry is invalid, then use that BN2 address to access the L2 cache memory 42 to read out a level 1 cache block and store the block into a L1 cache block in the L1 cache memory 22, and stores that L1 cache block number BN1X of that L1 cache block in the 76 field of the AL2 40, and set its corresponding field 77 to valid; also store the BN1X in the track table 20, and the BN1X can also be bypassed to the bus 29 for use by the tracker 47. If 77 in 40 is valid, then use the BN1X of the field 76 of the entry to directly fill in the track table 20 and bypass it to the bus 29 for use.

Refer to FIG. 9, which is an exemplary embodiment of an indirect branch target address generator of the processor system of this disclosure. The indirect branch target address is typically obtained by adding a base address stored in the processor core's register file to the branch offset contained in the indirect branch instruction. In FIG. 9, 93 is the adder, 39 is the IRB, 95 is a plurality of registers with comparator, 96 is a plurality of registers, the relationship between the two is CAM-RAM, and is one-to-one corresponded. 98 is selector. And 15, 11, 12, and 13 are the entry content of the track table 20 outputted via the bus 29. The system arranges a set of registers 95 and 96 for each indirect branch instruction. The adder 93 and the IRB 39 are shared by all indirect branch instructions. In the entry of indirect branch instruction in track table 20, the field 15 SBNY, the filed 11 type are defined the same as in FIG. 1; but the field 12 is used to store the register file (RF) address, and the field 13 is used to store the set number of the registers 95, 96. When the scanner 43 decodes the scanned instruction as an indirect branch instruction, the field 15 and field 11 of the track table entry are generated as described above, and the base address register file number in the instruction is stored to field 12, and the field 13 is set to ‘invalid’. When an entry corresponding to an indirect branch instruction is output from the track table 20 via the bus for the first time, its ‘invalid’ field 13 causes the system to assign it a set of registers 95, 96 (a set of multiple rows of CAM-RAM), and the set number of the set of registers is stored in the track table entry 13. The field 15 of the track table entry addresses IRB 39 and read the branch offset in that indirect branch instruction to send to one input port of the adder 93; use the track table entry 12 to address the RF to read its base address; or as shown in FIG. 9, it detects the write address of the register file. When the write address is the same as the address in the track table entry field 12, it transports and writes the execution result of the execution unit of the processor core into the bus 94 of RF to connect to another input port of the adder 93. The output 46 of the adder 93 is the branch target address, which is set to the TLB/tag unit 51 to match. At the same time the base address on the bus 94 is also stored in a usable row of the registers 95 in the register set pointed to by the track table entry field 13; the BN1 address obtained by matching the branch target instruction is stored via bus 89 into the same row of the register 96 in the register set pointed to by the field 13.

When the field 13 is ‘invalid’, or it is ‘valid’ but the base address on the bus 93 is not matched with the content in the register 95, the selector 98 selects the BN1 address on the bus 89 to output via the bus 99. When the type of the entry on bus 29 is an indirect branch instruction, the address of bus 99 is used by tracker 47; when the entry type on bus 29 is other type, the address on bus 29 is selected for use by tracker 47. The next time the same indirect branch instruction is executed, the register set number in the field 13 in the track table entry on the bus 29 selects the corresponding register set 95 and 96, and the RF address in the field 12 selects the data on bus 94 that is written back to that RF entry to compare with the content in register 95, if it is matched, then the BN1 address in the corresponding row of register 96 is output via bus 97, and selected by the selector 98 for use by the tracker; if it does not matched, then according to the above said method use the adder 93 to calculate the indirect branch target address to match into BN1 address and put it on bus 89, then the selector 98 select the address on bus 89 to output. The mismatch also causes the base address on bus 94 and the BN1 address on bus 89 to be stored in a row that is not used in registers 95 and 96. The replacement logic is responsible for allocating register set of 95, 96 for entries of indirect branch type in bus 29 whose field 13 is ‘invalid’, in the method of an LRU or the like. Thus, the present embodiment can map the base address of the indirect branch instruction to the L1 cache address BN1, eliminating the step for address calculation and address mapping.

Refer to FIG. 10, which is a diagram of the pipeline structure of the processor core in the processor system of this disclosure. 100 is the typical pipeline structure of the conventional computer or processor core, including pipeline stages I, D, E, M, W. Wherein pipeline stage I is the instruction fetch pipe stage, D is the instruction decode pipe stage, E is the instruction execution pipe stage, M is the data access pipe stage, and W is the register write back pipe stage. 101 is the pipeline stages of the processor core of this disclosure, and it does not contain I stage compared with 100. The conventional processor core generates the instruction address and sends it to the memory or cache to read (pull) the instruction. The cache system of this disclosure autonomously serve (push) instructions to the processor core, the processor core only needs to provide a branch decision 31 to determine the program execution direction, and a pipeline stop signal 32 to synchronize the cache system with the processor core. Thus, the pipelined structure of the processor core working with the cache system of this disclosure is different from the conventional pipeline structure, as there is no need for a pipeline stage to fetch instructions. In addition, the processor core using the cache system of this disclosure does not need to keep the Program Counter (PC). As shown in FIG. 9, the indirect branch target address is generated based on the base address kept in the register file, and no PC address is required. All other instructions are accessed by the BN address preserved in the cache system, needs the PC neither. Thus, it is not necessary to maintain a PC in the processor core while using the cache system of this disclosure.

Refer to FIG. 11, which is another exemplary embodiment of the processor system of this disclosure. FIG. 11 is an improvement of the embodiment of FIG. 8. In which the AL3 50, the TLB and the tag unit 51 of L3 cache, the L3 cache memory 52, the selector 54, the scanner 43, the L2 track table 88, the AL2 40, the L2 cache memory 42, the track table 20, the CT 37 of the L1 cache, the L1 cache memory 22, the instruction read buffer 39, the tracker 47, the tracker 48, and the processor core 23 have the same functions as the modules of the same numbers in the exemplary embodiment of FIG. 8. The L2 CT 103 and 102 is added. 102 is the indirect branch target address generator shown in the embodiment of FIG. 9. The cache organization in the embodiment of FIG. 11 is the same as the embodiment of FIGS. 5 and 8.

The structure of the L2 CT 103 is similar to the CT 37. Wherein each L2 cache block has a count number, a L3 cache address corresponding to this L2 cache block, source addresses of the branch source instructions targeting this L2 cache block, and their corresponding valid signals (Refer to the CT format of FIG. 7). As in the CT, the count number is the number of branch source instructions targeting this block. When the scanner 43 generates a L2 cache block corresponding track to to fill in the L2 track table 88, using the BN2 format branch target address on the generated track to address the row in the level 2 correlation list (CT2) 103 (hereinafter referred to as target row), fills the L2 cache address of the track which is filling the L2 track table (TT2) 88 (hereinafter referred to as source track) into the source address field of the target row and sets its valid signal to ‘valid’ and increases the Count number in the target row by ‘1’. Also, the corresponding L3 cache address of the source track is filled in the row in the L2 CT 103 corresponding to the source track. In addition, when the address to be filled into the entry of the L2 track table 88 is in BN3 format, use that BN3 address to address the entry of the level 3 active list (AL3) 50, and increase its Count number 79 by ‘1’.

When the entry address format of the output 29 from the track table 20 is in BN2 format, using the BN2 address to address the level 2 active list (AL2) 40. If the corresponding entry is invalid, then using the BN2 address (hereinafter referred to as the source BN2 address) to read instruction block from the L2 cache memory 42 to fill in a L1 cache block in the L1 cache 22 selected by the replacement logic. Then, using the source BN2 address to address the level 2 track table 88 to output the corresponding track to be stored in the track table 20. When the output 89 of the 88 is in the BN3 address format (hereinafter referred to as the target BN3 address), the target BN3 address is sent to the level 2 active list (AL3) 50 to be mapped into the BN2 address (hereinafter referred to as the target BN2 address), at this time the count number in the level 2 active list (AL3) entry pointed to by that target BN3 is decreased by ‘1’, while the value in the target row in the L2 CT 103 pointed to by the target BN2 address is increases by ‘1’; the target BN3 address is stored in the same target row; and the source BN2 address is also stored in the same target row, and the corresponding valid bit is set to ‘valid’.

When a L2 cache block is replaced, the level 2 pointer 78 points to the corresponding target row of the replaceable L2 cache block in the L2 CT 103, reading out the valid BN2 source addresses and using the BN2 source addresses to address the level 2 track table (TT2) 88 entries and replacing the BN2 target addresses (pointing to the target row) in the entries by the BN3 target address stored in the target row in 103, and set the valid bits of each BN2 source address in the target rows in 103 to ‘invalid’. Subtracts the Count number in the target row in 103 by the number of the valid BN2 source address. Using the afore mentioned BN3 target address to address the level 3 active list (AL3) 50 entry, increase its count number 79 by the same value that the count number in 103 subtracts.

The above-mentioned cache replacement method is based on the inclusive cache, that is, the content of higher level cache must be in the lower level cache. I The least correlation cache replacement method can also be applied to non-inclusive caches. It is possible to add a lock signal bit to the correlation table corresponding to the high-level cache block. When the lock signal bit is ‘0’, the operation is the same as the above. When the lock signal bit is ‘1’, the corresponding cache block can be replaced only when its correlation degree is ‘0’, that is, when there is no branch instruction targeting at that cache block (here, the end entry of the previous instruction block is also treated as an unconditional branch instruction). In the correlation table 37, for an L1 cache block whose lock signal bit is it can be replaced only when its corresponding count number 70 is ‘0’ and all valid bits 73 are ‘0’. In the level 2 correlation table (CT2) 103, the L2 cache block whose lock signal bit is ‘1’ can be replaced only when its corresponding count number and all valid bits are ‘0’.

For example, when replacing the L3 cache block of one way in one set of the L3 cache, using the BN3 address on the L3 pointer 83 to address the entry in the level 3 active list (AL3) 50, using all valid BN2 addresses within the entry to address the rows of the level 2 correlation list (CT2) 103 to set their lock signals to ‘1’. The L3 cache block can then be replaced. After the replacement, the cache is working in non-inclusive mode. The corresponding L3 cache block of the L2 cache block whose lock signal is set to ‘1’ has already been replaced, so it is not possible to maintain the integrity of the control flow information by replacing the BN2 address in the entry of the level 2 track table (TT2) 88 by the corresponding BN3 address. It needs to wait until the correlation degree of the L2 cache block of the is ‘0’, then the L2 cache block can be replaced.

A cache is in exclusive organization, If the low level cache is replaceable when all high-level caches are assumed to have a lock signal of ‘1’, that is, the high-level cache block can only be replaced when the correlation degree is ‘0’; or when the valid bits of all high-level cache sub-blocks in a activate list entry corresponding to one cache block (for example, the 81 in AL3 50) are all ‘1’, and the count number in the entry (for example, the 79 in 50) is ‘0’, then the cache block is replaceable. It is also possible to set the cache replacement method that a cache block in each cache level can be replaced when the correlation degree is ‘0’.

The 102 in FIG. 11 is an indirect branch target address generator in the exemplary embodiment of FIG. 9, which is controlled by the entry on the bus 29 outputted from the track table 20, obtains the base address 94 from the processor core 23, generates an indirect branch target address 46 and sends it via selector 54 to the 51 to do the virtual-real address transform and the address mapping, sends the BN1 branch target address 99 for use by the tracker 47. When the type of the entry on the bus 29 is an indirect branch instruction, the tracker 47 selects the address 99 outputted by 102; when the type of the entry on the bus 29 is other type, the tracker 47 selects the address on the bus 29 outputted from the track table 20. As can be seen from the exemplary embodiment of FIG. 11, all instructions are pushed by the cache system to the processor core 23, which provides only the branch decision 31 and the base address 94 of the indirect branch to the cache system. The indirect branch target address generator 102 may also be applied to the exemplary embodiment of FIGS. 4, 5, and 8 so that all of the instructions are pushed from the cache system to the processor.

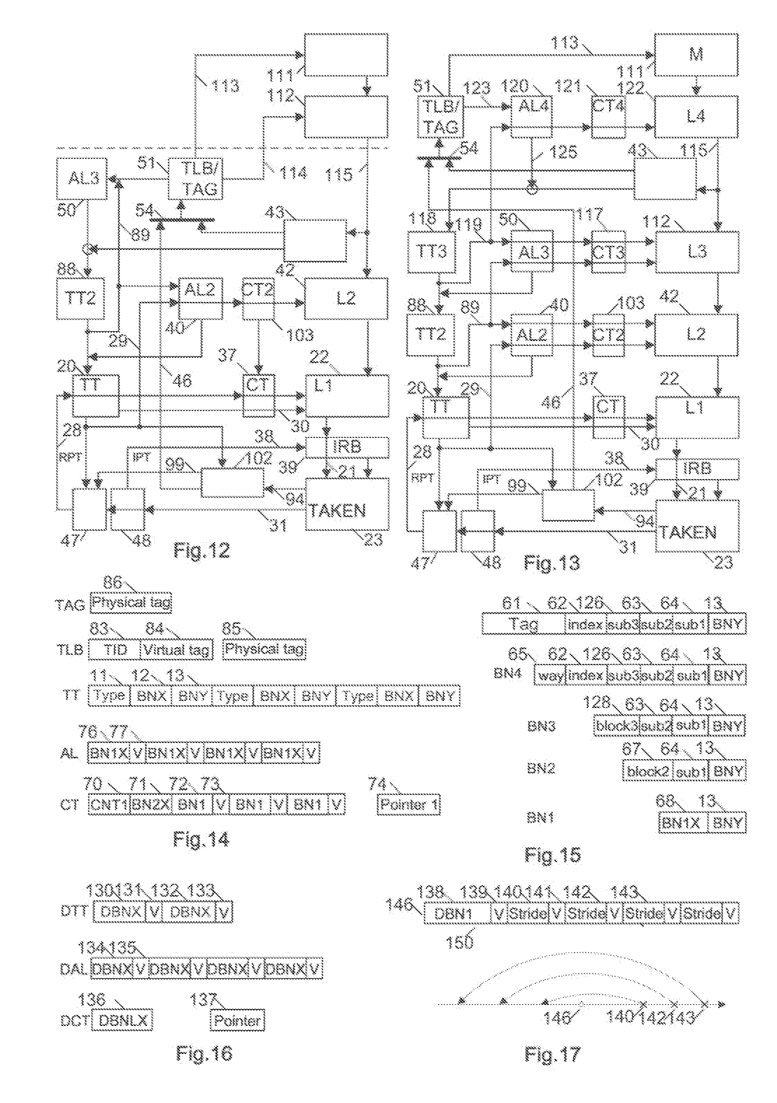

The method in the exemplary embodiment of FIGS. 4, 5, 8 and 11 may be further applied to control the addressing of the main memory. Refer to FIG. 12, which is an exemplary embodiment of the processor/memory system of this disclosure. The exemplary embodiment of FIG. 12 applies the method to the main memory outside the processor on the basis of the exemplary embodiment of FIG. 11, and other exemplary embodiments may be applied like this. Below the dashed line in FIG. 12 are the function blocks and the connections within the processor, which is, except that there is no L3 cache memory 52, exactly the same as the exemplary embodiment of FIG. 11. Wherein the AL3 50, the TLB and tag unit 51 of L3 cache, the selector 54, the scanner 43, the L2 track table 88, the AL2 40, the L2 cache memory 42, the L2 CT 103, the branch target address generator 102, the track table 20, the CT 37 of L1 cache, the L1 cache memory 22, the instruction read buffer 39, the tracker 47, the tracker 48, the processor core 23, have the same functions with the modules of the same numbers in the exemplary embodiment of FIG. 11. Above the dashed line in FIG. 12 is the newly added memory 111 and its address bus 113; and the newly added memory 112 and its address bus 114. the bus 115 sends the information block outputted from the memory 112 to the L2 cache memory 42 below the dashed line. The instructions in these information blocks are also scanned by the scanner 43 and the branch instruction information are extracted as described in the previous exemplary embodiment. Wherein the memory 111 is organized as main memory and is addressed by the memory address 113 whose source is the physical address not matched in the TAG of 51. And the physical address is mapped by the TLB in 51 from the virtual address generated by the 102 or the 43 is. Wherein the memory 112 is organized as a cache, and is addressed by the L3 cache address 114, which is generated by matching in the TAG of 51, or outputted from the L2 track table 88 via 89. In effect, it uses the memory 112 outside the processor to replace the L3 cache memory 52 in the exemplary embodiment of FIG. 11. The memory 111 is the low-level memory that is not shown but described in FIGS. 4, 5, 8, 11. So the exemplary embodiment of FIG. 12 is equivalent to the exemplary embodiment of FIG. 11 except that it moves the last level (L3) cache memory (52 in FIG. 11) to the outside of the processor. The cache organization (including the memory 112 as the L3 cache memory) in the exemplary embodiment of FIG. 12 is the same as the exemplary embodiment of FIG. 11.

The structure in the exemplary embodiment of FIG. 12 may have several different applications. The first application form is that the memory 111 is a large capacity memory with long access latency; and the memory 112 is a smaller capacity memory with shorter access latency. That is, the memory 112 is used as a cache of the memory 111. The said memory may be composed of any suitable memory device, such as a register or a register file (RF), an SRAM, a DRAM, a flash memory, a hard disk (HD), a solid-state drive (SSDs), or any suitable memory device or new form of memory in the future. The operation of this application is the same as the exemplary embodiment of FIG. 11. That is, the scanner 43 scans the instruction block sent from the memory 112 via the bus 115 to the L2 cache memory 42, calculates the virtual branch target address of the direct branch instruction therein, and sends the virtual branch target address to the selector 54 (102 also generates the virtual branch target address of the indirect branch instruction and sends it to 54 via bus 46). The virtual target address, after selected by 54, is mapped by 51 into a physical address, which is matched with the TAG in 51. If it does not match, the physical address is sent to the memory 111 via the address bus 113 to read the corresponding instruction block to store in the replaceable L3 cache block in the memory 112 selected by the replacement logic, which L3 cache block number is combined with the low bits of address outputted by the selector 54 to form the BN3 address to store into the L2 track table 88. If it is matched, then as described above, use the way number obtained by the matching and the index address outputted by the selector 54 to compose the BN3 address to address the L3 track table 50 to read the BN2 address to store into the L2 track table 88; if the entry in 50 is ‘invalid’, then directly use the BN3 to store in 88. The remaining operations are the same as those of the previous exemplary embodiments and will not be described here.

A specific exemplary embodiment of the first application may be using a flash memory as the memory 111, and a DRAM as the memory 112. The flash memory has larger capacity, lower cost, but long access latency, and limited number of writes. DRAM memory has smaller capacity, higher cost, but lesser access latency, and the unlimited write times. Thus, the structure of the exemplary embodiment of FIG. 12 exerts the advantages of flash memory and DRAM and obscures their respective disadvantages. In this first application, 111 is used together with 112 as the main memory of the computer system. In addition to 111, there are lower memory hierarchy such as hard drives. The first application is suitable to the existing computer systems and can use the existing operating systems. In the existing computer system, the memory manager in the operating system manages the memory, that is, recording which parts of the memory are being used and which parts are idle; the memory is allocated when the process needs it, and the memory is freed after the use of the process. Because it uses software for memory management, the efficiency is relatively low.

The second application of the exemplary embodiment of FIG. 12, uses a nonvolatile memory (such as a hard disk, a solid state hard disk or a flash memory, etc.) as the memory 111; and a volatile or nonvolatile memory to be the memory 112. In the second application of this exemplary embodiment of FIG. 12, 111 is used as the hard disk in a computer; and 112 is used as the main memory of the computer, but 112 is organized as a cache and therefore it may use the hardware of the processor to do the memory management. In this system architecture, it never or seldom uses the memory manager of the operating system for instructions. The instructions in the memory 111 are stored into the memory 112 as described above, and in some specific exemplary embodiments the said instruction block may be a page of the virtual memory, and at this time, each of the tags of the tag unit TAG can represent a page.

Assuming the address of this specific exemplary embodiment is in the format of FIG. 6, and the memory 111 (hard disk) address 113 is divided into a tag 61, an index 62, an L2 sub-address 63, an L1 sub-address 64, and an L1 cache block offset (BNY) 13. In this exemplary embodiment, the memory 111 (hard disk) address can have a larger address space than the normal main memory address to address the entire hard disk, wherein 63, 64 and 13 can be combined to be the offset address within a page; the combination of 61 and 62 is the page number. The address BN3 of the memory 112 (main memory, i.e., the L3 cache in the previous exemplary embodiments) is composed of the way number 65 and the index 62, the L2 sub-address 63, the L1 sub-address 64, and the intra-block offset (BNY) 13; wherein the way number 65 can be combined with the index 62 to form the block address of the main memory 112, where a block is a page as afore mentioned; wherein the 65, 62, 63 are combined to address an L2 instruction block in the main memory block (page); and all fields except the intra-block offset 13 are combined to form BN3X, which can be used to address an L1 instruction block in the main memory instruction block (page). The address BN2 of the L2 cache consists of an L2 cache block number 67 and an L1 sub-address 64, and an intra-block offset (BNY) 13; wherein the L2 cache block number 67 addresses an L2 cache block; the fields except the intra-offset 13 are collectively referred to as BN2X, which can be used to address an L1 instruction block in the L2 cache block. The address BN1 of the L1 cache consists of an L1 cache block number 68 (BN1X) and an intra-block offset (BNY) 13. The intra-block offset (BNY) 13 in the above-described four address formats is the same, and the BNY portion does not change when performing the address transform. The L2 block number 67 in the BN2 address format points to a L2 cache block, and the L1 sub-address 64 points to one of the four L1 instruction blocks in the L2 cache block. Similarly, the way number 65 and index 62 in the BN3 address format point to a main memory instruction block, and the L2 sub-address 63 points to one of the two L2 instruction blocks in the main memory instruction block, and the L1 sub-address 64 points to one of the several L1 instruction blocks in the selected L2 instruction block.

When the operating system controls the processor in FIG. 12 to start executing a new thread, the address (in address format of the memory 111) of the starting point of the new thread is passed through the selector 54 (assuming that the selector 54 in this exemplary embodiment has a third input for the starting address to enter) and sent to 51. The index 62 in the starting point address is used to address the tag unit TAG in 51 to read the label contents in the respective ways to match with the tag 61 in the starting address. If not matched, then use the 61 and 62 in the starting point address via the bus 113 to address the memory 111 to read the corresponding page (instruction block) to store in the memory 112 and in the set pointed to by the index 62 of the starting point address and in the way selected by the replacement logic of the main memory (that is, the L3 cache above); at the same time, the fields 61 and 62 of the starting point address are stored into the same way and same set in the tag unit of 51.

After that, or when 61 of the starting point address matches the contents of the tag in the tag unit, the system controller uses the way number 65, the index 62 of the starting point address, the L2 sub-address 63 to read an L2 instruction block from the memory 112 (main memory), and the L2 instruction block is then stored in the L2 cache memory 42 and in an L2 cache block selected by the L2 block number 67 given by the L2 cache replacement logic; and that L2 block number 67 is stored into the entry 80 pointed to by the above 65, 62, and 63 in the AL3 50 and the corresponding valid bit 81 in the entry is set to ‘valid’. The scanner 43 scans that L2 instruction block, extracts the branch instruction information therein, and generates the track to store into the L2 track table 88.Thent, the system controller further uses the combination of the L2 block number 67 and the L1 sub-address 64 in the starting address to read an L1 instruction block in 42 and stores that L1 instruction block into a L1 cache block in the L1 cache memory 22, which is pointed to by the L1 block number 68 produced by the L1 cache replacement logic; the corresponding track in the L2 track table 88 is also stored into the track table 20, in the process, the address of BN3 address on the track is replaced with BN2 as described above; that L1 block number 68 is also stored into the AL2 40 and into the entry 76 pointed to by the above 67 and 64, and set the valid bit 77 of the entry to be ‘valid’. At last, the system controller combines the above L1 block number 68 with the L1 block offset BNY 13 to be the BN1 address and put it into the register 26 of tracker 47, and makes the read pointer 28 to point to the starting point instruction in the L1 cache memory 22 and also point to the corresponding entry in track table 20. The subsequent push operation to the processor core is similar to the previous exemplary embodiments. In general, the new thread starting point address injected by the operating system, or the hard disk address generated by the scanner 43 or the indirect branch address generator 102 is selected by the selector 54 and then sent to the tag unit in 51 to match. If the match is successful, use the matched BN3 address to address the LA3 50. If the output entry of the 50 is ‘valid’, then use the BN2 in the entry to address the AL2 40. If the entry outputted from the 50 is ‘invalid’, then use the above BN3 address to directly address the memory 112 (main memory) to output L2 instruction block to the L2 cache memory 42. If the matching in the tag unit 51 of the hard disk address is not successful, then address the memory 111 (hard disk) via bus 113, and read the corresponding instruction block (page) to store into the memory 112 (main memory) and into the main memory block selected by the cache replacement logic and replace the previous instruction block in it. This replacement from the hard disk to the main memory is totally controlled by the hardware, and do not need to invoke the software operation in general. The replacement logic can use a variety of algorithms such as LRU, NRU (not recently used), FIFO, clock, etc.

If the address space of the above hard disk address is greater than or equal to the address space of the memory 111, there is no need for the TLB in 51 of the exemplary embodiment of FIG. 12, and the hard disk address is the physical address. The starting point address injected by the operating system is the physical address, and the memory address BN3 (for addressing the memory 112) obtained by mapping this address is the mapping of the physical addresses. The remaining BN2 address, BN1 address is the mapping of the BN3 address, and therefore the mapping of the physical address. The memory 111 (hard disk) is the virtual memory of the memory 112 (main memory), and the memory 112 (main memory) is the cache of the memory 111 (hard disk). So that there is not a situation in which the address space of the program is larger than the address space of the main memory. The same program being executed at a same time has the same BN3 address, and the BN3 addresses of different program being executed at a same time are different. So that the same virtual address of different programs at the same time will be mapped into different BN addresses and will not be conflicted. The processor core in the push architecture does not generate instruction addresses. So that it can directly use the physical hard disk address as the address of the processor. It is not necessary to generate virtual addresses by the processor core and then map it into physical addresses to access the memory in the case of the existing processor system.

The memory 111 and the memory 112 of the exemplary embodiment of FIG. 12 may be encapsulated in the same package as the memory. The interface between the processor and the memory in the exemplary embodiment of FIG. 12 additionally adds the cache address BN3 bus 114 in addition to the existing memory address bus 113 and the instruction bus 115. Although the boundary between the memory and the processor in the exemplary embodiment of FIG. 12 is shown as the dashed line, it is also possible to move some of the functional blocks from one side of the boundary to the other. For example, the TLB and the tag unit TAG in the AL3 50, 51 can be placed on the memory side above the dashed line, which is also logically equivalent to the exemplary embodiment of FIGS. 12 and 11. In addition, a singular or a plurality of nonvolatile memory 111 and 112 and the memory chip (which may add an external interface) below the dashed line of FIG. 12 may be interconnected via the TSV, encapsulated in a single package to be a complete computer of micro-physical scale.

Refer now to FIG. 13, which is another exemplary embodiment of the processor/memory system of this disclosure. The exemplary embodiment of FIG. 13 is a more general expression of the exemplary embodiment of FIGS. 8, 11 and 12. Wherein the memory 111, the L3 cache memory 112, the AL3 50, the L3 cache TLB and tag unit 51, the selector 54, the scanner 43, the L2 track table (TT2) 88, the AL2 40, the L2 cache memory 42, the L2 CT (CT2) 103, the indirect branch target address generator 102, the track table 20, the L1 CT 37, the L1 cache memory 22, the instruction read buffer 39, the tracker 47, the tracker 48, and the processor core 23 have the same functions as the modules of the same numbers in the exemplary embodiment of FIG. 12. An level 4 active list (AL4) 120, an level 4 correlation table (CT4) 121, and an L4 cache memory 122 are added, which is addressed by the BN4 bus 123 generated by the 51. An L3 track table 118 and an L3 CT 117 are also added, which stores the count numbers extracted from the AL3 50 in the exemplary embodiments shown in FIGS. 8, 11 and 12 so that the format of active list of each level is uniform. That is, there is no count number in 50 in the exemplary embodiment of FIG. 13, and the count number is stored in 117.

The lowest level 111 of the memory hierarchy in the exemplary embodiment of FIG. 13 is a memory, which is addressed by the memory address 113. The remaining memory levels are different levels of cache of 111, which are addressed by the corresponding BN cache addresses. Wherein the lowest level cache, the L4 cache 122 in the figure, is of way-set associative organization. The remaining higher hierarchy levels of cache are of fully-associative organization. The scanner 43 is located between the L4 cache memory 122 and the L3 cache memory 112. TLB/TAG 51 is in the L4 cache. Each higher-level cache of scanner 43 has its track table, such as 118, 88, 20. All cache levels except the highest-level cache have active list, such as 120, 50, 40. All cache levels have correlation table, such as 121, 117,103, 37. The format of each table is shown in FIG. 14.

FIG. 14 is the formats of each table of the exemplary embodiment of FIG. 13. The format of the tag unit in 51 in FIG. 13 is physical tag 86.The CAM format of the TLB in 51 is the thread number 83 and the virtual tag 84, and the RAM format is the physical tag 85. In FIG. 13, the selector 54 selects the outputted thread number 83 and the virtual tag 84, which is then mapped to the physical tag 85 in the TLB; the index address 62 in the virtual address reads the physical tags 86 in the tag unit to match with 85 to obtain the way number 65. The way number 65 and the index address 62 in the virtual address combines to form a L4 cache block address 123. The physical address selected by the selector 54 may be directly matched with the physical tag 86 in the TAG in the absence of the TLB as 51 described above. The track table entries in FIG. 14 contain type 11, cache block addresses BNX 12 and BNY 13, and may also contain SBNY 15 to determine the branch execution time point. The cache block address 12 in each level of the track table may be BN format at this level or lower level, for example, 12 in the L3 track table 118 may be BN3X or BN4X format. The active list entry contains the cache block number 76 of the corresponding sub-block, whose format is the cache block number of the higher level, such as the AL3 50 stores the BN2X; and the corresponding valid bit 77. The function of the active list is to map the cache address of this level to a higher-level cache address. There is a count number 70 in the correlation table, which means that the number of entries in this cache level or the higher hierarchy levels which use this cache block as the branch target; and the lower level cache block number 71 corresponding to this cache block; and the address 72 and its corresponding valid bit 73 of the track table entry in the present cache hierarchy level which use the cache block as branch target. The pointer 74 shared by each way points to the cache block which is not replaced for the longest time as described above; if the count number 70 corresponding to the cache block is smaller than the preset replacement threshold, the cache block may be replaced. When replacing, use the address in 72 whose 73 is ‘valid’ to address the entry in track table, and replace the cache block number of the present level in the track table entry with the lower level cache block number 71. Except for the L4 CT 121, there is only count number 70, without 71, 72, 73, since there is no track table this level, and no address replacement within the track table entry is required.

When an instruction block is transmitted from the memory 122 (L4 cache memory) via the bus to the L3 cache memory 112, the scanner 43 extracts the information of the branch address in the instruction block, generates the track entry type, and calculates the branch target address. The branch target address is selected by the selector 54 to send to 51 to match with the tag unit. If not matched, then use the branch target address via the bus 113 to address the memory 111, read the corresponding instruction block to store in the memory 122 and in the L4 cache block selected by the replacement logic of the L4 cache (the AL4 129 and L4 CT 121, etc.) If matched, then use the matched BN4X address 123 to address the AL4 120. If the 120 entry is valid, then combine the BN3X address in the entry and the BNY of the branch target address into the BN3 address and store the BN3 via the bus 125 into the entry of the L3 track table 118 which is corresponding to that branch instruction; if the 120 entry is invalid, then directly combine the BN4X address and the BNY address into the BN4 address to store into the 118 entry.

Refer to FIG. 15, which is the address format of the processor system in the exemplary embodiment of FIG. 13. The memory address is divided into a tag 61, an index 62, an L3 sub address 126, an L2 sub address 63, an L1 sub address 64, and a block offset (BNY) 13. The address BN4 of the L4 cache is composed of the way number 65, the index 62, the L3 sub address 126, the L2 sub address 63, the L1 sub address 64, and the block offset (BNY) 13; wherein the part except BNY 13 is called BN4X. The address BN3 of the L3 cache is composed with the L3 cache block number 128, the L2 sub address 63, the L1 sub address 64, and the block offset (BNY) 13; and the part except the block offset 13 is called BN3X. The address BN2 of the L2 cache is composed of the L2 cache block number 67 and the L1 sub address 64, and the block offset (BNY) 13; the part except the block offset 13 is called BN2X, which is used to address an L1 instruction block in the L2 cache block. The address BN1 of the L1 cache consists of the L1 cache block number 68 (BN1X) and the block offset (BNY) 13. The block offset (BNY) 13 in the above-described four address formats is the same, and the BNY portion does not change when the address conversion is performed.

When the L2 instruction block is transferred from the L3 cache memory 112 to the L2 cache memory 42, the corresponding track is read via the bus 119 from the L3 track table 118, and the BN4 format address in the track entry is used to address the AL4 120; if the entry 120 is valid, use its BN3X address to fill in the track table entry of 118 and bypass the BN3X to bus 119 to store into the corresponding entry in the L2 track table 88; if the entry 120 is invalid, then use the BN4 address on the bus 119 to address the memory 122, and read the corresponding instruction block to fill into the memory 112 and into the L3 cache block selected by the BN3X address given by the L3 cache replacement logic (the AL3 50 and the L3 CT 117, etc.). The given BN3X address is stored in the entry of in the AL4 120 pointed to by the above BN4, and is stored in the corresponding entry in the L3 track table 118, and the BN3X address is also bypassed to the bus 119 and also stored in the corresponding entry of the L2 track table. If the output on the bus 119 is already BN3X address, then use that BN3X address to address the AL3 50. If the entry of 50 is valid, then use the BN2X address in the entry to store in the corresponding entry of the L2 track table 88; if entry of 50 is invalid, then use the BN3X address on 119 to address the memory 112, and read the corresponding L2 cache block to store into the L2 cache memory 42 and into the L2 cache block pointed to by the BN2X address given by the L2 replacement logic (the AL2 40 and the L2 CT 103); the BN2X is also stored in the L2 track table 88, and the BN2X is also stored in the entry addressed by the above mentioned BN3X in the AL3 50; and the BN2X is also stored into the L2 track table 88.

When the L1 instruction block is transferred from the L2 cache memory 42 to the L1 cache memory 22, the corresponding track is read via the bus 89 from the L2 track table 88, and the BN3 format address in the track entry is used to address the AL3 50; if the entry of 50 is valid, use its BN2X address to fill in the track table entry of 88 and bypass the BN2X to bus 89 to store into the corresponding entry in the L1 track table 20; if the entry of 50 is invalid, then use the BN3 address on the bus 89 to address the memory 112, and read the corresponding instruction block to fill into the memory 42 and into the L2 cache block selected by the BN2X address given by the L2 cache replacement logic (the AL2 40 and the L2 CT 103, etc.). The given BN2X address is stored in the entry of in the AL3 50 pointed to by the above BN3, and is stored in the corresponding entry in the L2 track table 88, and the BN2X address is also bypassed to the bus 89 and also stored in the corresponding entry of the L1 track table 20. If the output on the bus 89 is already BN2X address, then use that BN2X address to address the AL2 40. If the entry of 40 is valid, then use the BN1X address in the entry to store in the corresponding entry of the L1 track table 20; if entry of 40 is invalid, then use the BN2X address on 89 to address the memory 42, and read the corresponding L1 cache block to store into the L1 cache memory 22 and into the L1 cache block pointed to by the BN1X address given by the L1 replacement logic (the L1 CT 37, etc.); the BN1X is also stored in the entry addressed by the above mentioned BN2X in the AL2 40; and the BN1X is also stored into the L1 track table 20.

When the instruction block is pushed from the L1 cache memory 22 to the processor core 23 or the IRB 39, the corresponding track is read via the bus 29 from the L1 track table 20, and the BN2 format address in the track table entry is used to address the AL2 40; if the entry of 40 is valid, then use its BN1X address to fill in the track table entry of 20 and bypass the BN1X to the bus 29; if the entry of 40 is invalid, then use the BN2 address on bus 29 to address the memory 42, and read the corresponding instruction block to store into the memory 22 and into the L1 cache block pointed to by the BN1X address given by the L1 cache replacement logic (L1 CT 37, etc.). The BN1X address is stored in the entry of the AL2 40 pointed to by the BN2 address, and is also stored in the corresponding entry in the L1 track table 20. If the output on the bus 89 is already BN1 address, then the BN1 address is stored into the register in the tracker 47 and becomes the read pointer 28, which is used to address the track table 20 and the L1 cache memory 22, to push instructions to the processor core 23 or the IRB 39. This ensures that for the instructions in the L1 cache memory 22, their branch targets, and the fall-through cache blocks are at least already in the L2 cache memory 42 or are in the process of being stored into 42. The remaining operations are the same as described in the previous examples, and is not described here.

Although the exemplary embodiment of FIG. 13 is illustrated with the memory/processor system that simultaneously executes instructions of two branches of the branch instruction, the memory hierarchy structure is also suitable to the processor cores of other architectures, such as the out-of-order multi-issue processor system that the processor core generates address to address the L1 cache of instruction read buffer. The method and system of the exemplary embodiment of FIG. 13 can be also applied to the data memory hierarchy and data pushing, causing the memory hierarchy to push data to the processor core as well. For the sake of explanation, the following exemplary embodiments assume that the data memory has the same memory hierarchy levels as the instruction memory, i.e., it have memory, L4 cache, L3 cache, L2 cache, L1 cache and the data read buffer, which are corresponding to each level of the instruction memory. Thus, the address format of the data memory hierarchy is the same as the exemplary embodiment of FIG. 15 except that the memory address is the data address but not the instruction address at this time. Each BN address can be a DBN (Data Block Number) address to distinguish with the BN address, and to adapt with the separated instruction cache and data cache. If in a memory level, a single memory is used as the unified cache (to store both instructions and data), then the address of that level is still named BN.

Each memory level also needs data track table (DTT here after), the data active list (DAL here after), the data correlation table (DCT hereafter) and the pointers to support the store operation of the data memory. Refer to FIG. 16, which is the format of the DTT, DAL and the DCT. The DTT does not need to store the branch target address, so it is only necessary to store the block address DBNX 132 of the next block and its valid bit 133. Alternatively, it is possible to add the block address 130 of the previous data block and its valid bit 131 so as to be used when the data is accessed in reverse order. Also, it may completely not use the DTT. The format of the data active list (DAL here after) is the same as the AL format 76, 77 shown in FIG. 14, where the field 134 stores the data block address DBNX, and the field 135 stores the corresponding valid bit. Use the data block address (such as the block-2 address 67 in FIG. 15) to address one row in the DAL of the present level, and use the sub address (such as the sub-2 address 64 in FIG. 15) to address a set of 134, 135 in that row. If the valid bit 135 is ‘valid’, then read the block address of the higher level in 134 from DAL to access the higher-level data memory. That is, the DAL maps the memory hierarchy address to the address of the higher memory level. The DCT stores only the corresponding lower-level address 136. That is, the DAL can map the memory hierarchy address to the corresponding higher-level address, and the DCT can map the memory hierarchy address to a lower-level address (DBLNX in FIG. 16 represents a lower level address). The pointer 137 is used for cache replacement. The replacement method of the data cache can use the instruction replacement method disclosed in this disclosure, but there is no count number in the correlation table of the data cache because there is no branch instruction that jumps into the data cache, so the replacement does not need to consider replacing the address in the track table that use the data cache block as the target, and also do not need to record the branch source address. The L1 cache only needs to use the pointer 137 to record the last replaced cache block. The pointer 137 is traversed in single-direction, or is replaced by LRU, LFU, etc. The replacement method of L2, L3, L4 cache are the same with that of the instruction memory, and the cache block can be replaced as long as there is no corresponding higher level cache block. It can use the pointer 137 of the present level to traverse in single-direction to read each entry of active list, and if all address fields in an entry are ‘invalid’, then the corresponding cache block can be replaced. The L1 cache replacement method of the instruction cache disclosed in this disclosure can also be implemented by LRU, LFU, etc.

The serving data memory hierarchy also uses the stride table 150 to record the address difference stride of two adjacent data accesses by the same data access instruction. Please refer to FIG. 17, which is the stride table format and its working mechanism. 150 is a memory, where each row corresponds to a data access instruction (such as LD or ST), which is addressed by the instruction address of the data access instruction. Each row has a data address 138, in the following exemplary embodiment, the format of 138 is DBN1, that is the L1 data cache address, whose format is DBN1X and DBNY, and similar to 68 and 13 in FIG. 15, the field 139 is the status bit of 138. There are also multiple sets of strides, in which one set is 140 and the corresponding valid bit 141; 142 and 143 are the strides of other sets. Each set of strides, such as 140 and its corresponding valid bit 141, is selected by the data access instruction at a particular branch loop layer. Please refer to the lower part of FIG. 17, the straight line represents the sequential instructions executing in the direction of the arrow, the arcs represent the back-ward branches, the cross represents the branch instruction, and the triangle represents the data access instruction. Wherein 146 is a data access instruction and the stride table row 150 in the upper part of FIG. 17 corresponds to 146. Wherein when the branch decision of the branch instruction 140 is ‘take branch’, the inner loop stride of the data access instruction 146 is stored in the stride field 140 in the row 150 corresponding to 146; when the branch decision of the branch instruction 140 is ‘not branch’ and the branch decision of the branch instruction 142 is ‘take branch’, then the middle loop stride of the data access instruction 146 is stored in the stride field 142 in the row 150 corresponding to 146; when the branch decision of the branch instruction 140 is ‘not branch’ and the branch decision of the branch instruction 142 is ‘not branch’, and the branch decision of the branch instruction 143 is ‘take the branch’ then the outer loop stride of the data access instruction 146 is stored in the stride field 143 in the row 150 corresponding to 146. That is, each branch decision is assigned a priority, and the backward branch instruction immediately following the data access instruction has the highest priority, and the priority of the other backward branch instruction is decremented in descending order. The higher-priority branch instruction whose branch decision is ‘execute branch’ will obscure the lower-priority branch instructions so that it does not affect the readout of the stride table 150. The forward branch instructions are not recorded in the stride table. An adder may be used to add the data address DBN1 138 in row 150 with the stride selected by the branch decision such as 140, to obtain the next data address to access the data memory hierarchy system in advance, to read and serve the data to the processor core.

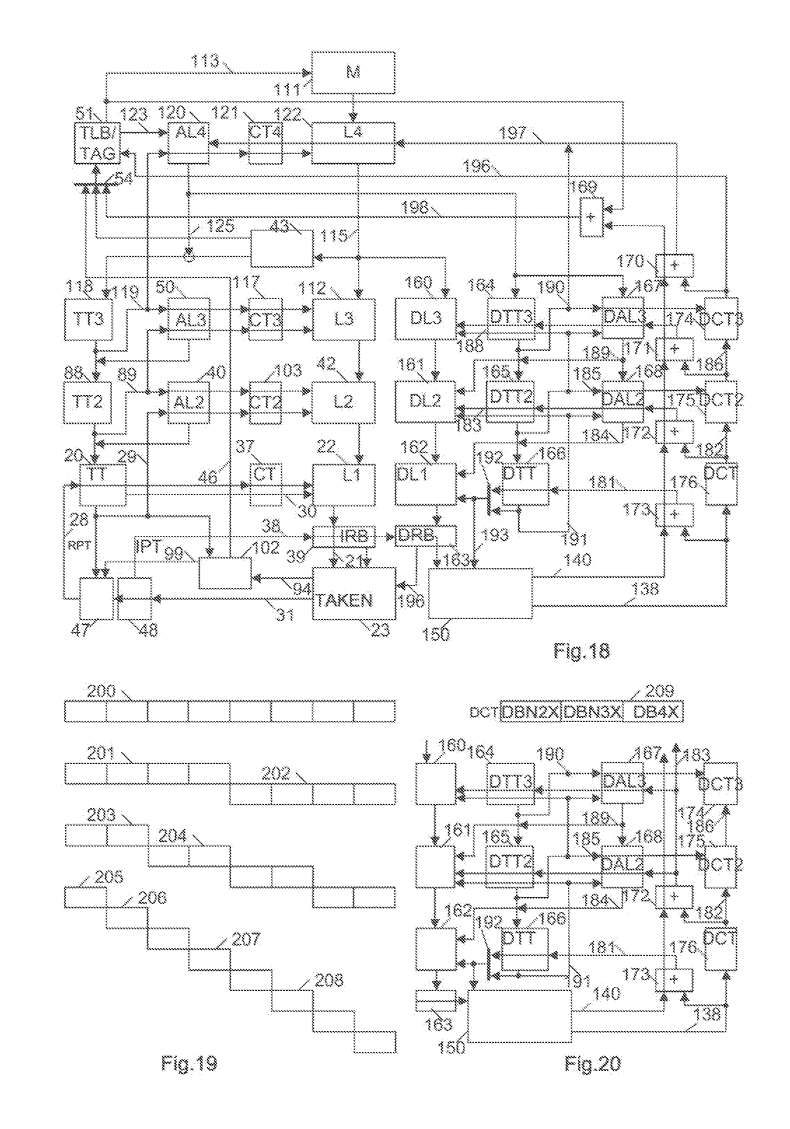

Refer to FIG. 18, which is another exemplary embodiment of the processor/memory system of this disclosure. The left half of FIG. 18 is an instruction serving processor system similar to the embodiment of FIG. 13, and the right half is the data serving memory hierarchy. The L3 track table 118, the L3 CT 117, the L3 cache memory 112, the AL3 50, the TLB and tag unit 51 of L3 cache, the scanner 43, the L2 track table 88, the AL2 40, the L2 cache memory 42, the L2 CT 103, the indirect branch target address generator 102, the track table 20, the L1 CT 37, the L1 cache memory 22, the instruction read buffer 39, the tracker 47, and the processor core 23 have the same functions as the modules of the same numbers in the embodiment of FIG. 13. The functions of the memory 111, the AL4 120, the L4 CT 121, and the L4 cache memory 122 are similar to those in the embodiment of FIG. 13, but the difference is that they store not only instructions but also data and the information related to data, such as the data cache block number, etc. The entry of AL4 120 can store both the L3 instruction cache address BN3 and the L3 data cache address DBN3. The selector 54 is now a three-input selector. In addition to the scanning function of the instructions in the embodiment of FIG. 13, the scanner 43 also calculates the sequential next data block address (or in reverse order the previous data block address) of the data block passing through the bus 115. The right half has an L3 data cache memory 160, an L2 data cache memory 161, an L1 data cache memory 162, a data read buffer (DRB) 163; a stride table 150; an L3 data track table (DTT3) 164, an level 2 data track table (DTT2) 165, a level 1 data track table (DTT) 166; a level 3 data active list (DAL3) 167, a level 2 data active list (DAL2) 168; adders 169, 170, 171, 172, 173; an level 3 data correlation table (DCT3) 174. An L2 data correlation table (DCT2) 175, an L1 data correlation table (DCT) 176; and a selector 192.

In FIG. 18, the memory 111 is addressed by a memory address, the memory 122 is a set associative cache organization structure, and the other levels of caches are all in fully-associative cache configurations. The same as the embodiment of FIG. 13, the memory 111 in the embodiment of FIG. 18 may be used as the main memory of the processor/memory system, at this time, 122 is an unified last level cache of the processor. Or in another system organization, 111 is the system's hard disk, 122 is the main memory configured as a cache level, 112 is the processor's last level of instruction cache, and 160 is the processor's last level of data cache. The instruction push in the left half of the embodiment of FIG. 18 is identical to that of the embodiment of FIG. 13, and the description is not repeated here again. The data processing of the right half is described below. The entries of the Data Read Buffer (DRB) 163 correspond one-to-one to the entries of the IRB 39. When a data load instruction in the IRB is pushed into the processor core 23 for execution by the IPT 38, 38 also reads out the data from the corresponding DRB entry and pushed via the bus 196 to the processor core 23 for processing. So that the task of the data memory hierarchy is to preload the data to be used by the processor core to the entry of DRB corresponding to the data access instruction in the IRB, so that the data is pushed together with the instruction to the processor core 23 (data and instructions do not necessarily need to be pushed at the same time, because processor core usually executes the data load instruction and inputs its corresponding data usually in a different pipeline stage).

When an L1 instruction block is stored in IRB 39, its corresponding DRB 163 is cleared. When the decoder (the instruction decoder in the processor core 23 or the dedicated instruction decoder attached to the IRB 39 at this time) translates an instruction sent to the processor core 23 as a data load instruction, the system then allocates one row in the stride table 150 for it. The status bit 139 of the row is set to ‘0’. According to the status bits of ‘0’, the system makes the data address generated by the processor core 23 executing the data load instruction to be outputted via bus 94, bypassed by 102 via bus 46 and selector 54, to be matched in 51. If the data is not matched, then as the exemplary embodiment of FIG. 13, use the data address via bus 113 to access the memory 111 to read a L4 data block, and store it to the L4 cache block of memory 122, which is pointed to by the combination of the way number given by the L4 cache replacement logic (the 65 in FIG. 15) and the index 62 of the data address. And save that data address into the entry in the tag unit of 51 pointed by the same 65 and 62.

The system further uses the 65 and 62 above along with the L3 sub address 126 in the data address to read the L3 data block from the memory 122, and stores it in the L3 data cache memory 160 via the bus 115 and in the L3 cache block selected by the L3 data block number 128 given by the L3 data cache replacement logic, and stores that L3 block number 128 in the entry field in the AL4 120 pointed to by 65, 62, and 126 and sets that field to ‘valid’. And at the same time, that 65 and 62 (L4 block number) are stored into the entry of DCT 174 pointed to by the above 128. In addition, the scanner 43 calculates the address of the next L3 data block of that L3 data block (i.e., the data address plus the size of a L3 data block), and sends the address to the tag unit in 51 to match the BN4 address. Use that BN4 address to access the AL4 120 to map it into the DBN3X address, which is combined with the DBNY 13 in the data address to get the DBN3 address. The resulting DBN3 or BN4 address is stored into the field 132 of the entry in DTT3 164 pointed to by the above 128. If the next L3 data block is still in the same cache block, then add ‘1’ on the above 126, combine it with the original 65, 62 to get the next L3 data block DBN3 address in the order, without going through the tag unit in 51 for mapping. Alternatively, the next L3 data block may also be filled into the L3 data cache memory 160 and the corresponding entries in the 120 and 174 are filled as described above; generally, the L3 data block after the next L3 data block is not need to be filled in 160.

The system further uses the 128 above along with the L2 sub address 63 in the data address to read the L2 data block from the DL3 160, and stores it in the L2 data cache memory 161 and in the L2 cache block selected by the L2 data block number 67 given by the L2 data cache replacement logic, and stores that L2 block number 67 in the entry field in the AL3 167 pointed to by 128, 63, and sets that field to ‘valid’. And at the same time, that 128 (L3 block number) is stored into the entry of DCT2 175 pointed to by the above 67. Alternatively, add ‘1’ to the above 63, and combine it with 128 to address the AL3 167, and if the entry is ‘valid’, it means the next L2 cache block is already in the L2 cache; if the entry is ‘invalid’, then from the DL3 memory 160 use that combined address of 128 and the 63 plus ‘1’ to read the L2 data block, and store the L2 data block into the DL2 memory 161 and into the another L2 data cache block pointed to the L2 cache block number 67 given by the L2 cache replacement logic, and store that another 67 into the entry pointed to by the address of the combination of the 128 and 63 plus ‘1’, and set that entry to be ‘valid’.

If the address of the next L2 data block exceeds the boundary of the L3 cache block, the entry pointed to by the 128 in the DTT3 164 is read out via the bus 190, and if the content of the entry is in the BN4 format, then use the BN4 address to access the AL4 120 via bus 197. If the entry of 120 is valid, then use the DBN3 address in the entry to store into the entry of 164 pointed to by the 128 and replace the original BN4. If the entry of 120 is invalid, then use that BN4 address on bus 197 to access the memory 122 to read the next L3 data block to store in the memory 160, and the corresponding entries 164, 167, 174, and 120 are filled in the method described above. This ensures that when the content of a L3 data block is stored into the L2 data cache, the next L3 data block is stored in the L3 data cache. Alternatively, when the entry of DTT3 164 pointed to by the above 128 is in the DBN3 format, use the DBN3 to address the AL3 167 via bus 190 as described above, in order to make the next L2 data block of the L2 data block being filled now is also filled into 161. Also, it can store the last data block into the data cache according to the need, and at this time, it uses the field 130 of the track table. It is also possible to completely not use the data track tables 164, 165, 166. At this point the system does not have the function to automatically fill the next or previous L2 data block that exceeds the L3 data cache boundary. The prefect of the other data memory levels is done in the same way.

The system further reads the L1 data block from the L2 data cache memory 161 using the combination of the above 67 with the L1 sub address 64 in the data address, and stores the L1 data block into the L1 data cache memory 162 and into the L1 data cache block pointed to by the L1 data block number 68 given by the L1 data cache replacement logic; and stores that L1 data block number 68 into the entry field of the DAL2 168 pointed to by the 67, 64 and sets the field to ‘valid’. At the same time, the 67 (L2 block number) is stored in the entry in the DCT 176 pointed to by the above 68. Alternatively, the entry of DTT2 165 pointed to by the above-mentioned 67 is read out. If the content of the entry is in the BN3X format, then use that BN3 address to access the DAL3 167 via the bus 185, and if the entry of 167 is ‘valid’, then use the BN2X address in the entry of 167 to write back to the 165 via bus 189 to replace the BN3X address. If the entry of 167 is ‘invalid’, then use the address on 185 to address the DL3 160 to read the L2 data block to store into the DL2 161 and into the L2 cache block pointed to by another L2 cache block address 67 given by the cache replacement logic. That another 67 is also stored in the entry of DAL3 167 addressed by the 185, which is also stored in the DTT2 165 to replace the BN3X address. Also, use that address 67 to establish corresponding entries in the DAL2 168 and the DCT2 175 for the above L2 cache block. This ensures that when the content of a L2 data block is stored in the L1 data cache, the next L2 data block is stored in the L2 data cache.

The system further uses the above 68 and the DBNY 13 in the data address together to be the L1 data cache address DBN1 and stores it into the field 138 of the row of stride table 150 corresponding to the above load data instruction, and sets the status field 139 of that row to ‘1’. According to the status of ‘1’, the system uses the above DBN1 to access the L1 data cache memory 162, reads the data and stores it into the entry in the DRB 163 corresponding to the above data loading instruction, so that the data can be pushed to the processor core 23 for processing along with the instruction. When the data is pushed to the processor core 23, the system starts perfecting the next data into the DRB for the prefect when the same data load instruction is executed again. Because the state field 139 is ‘1’, the process of perfecting data for the push is exactly the same as described above, except that when generating the new 68 and 13 (DBN1), firstly subtract the DBN1 with the last DBN1 in the field 138 of that row in the stride table 150, and uses the difference to be the stride to store into the entry selected by the branch decision, such as in 140. After that, write the new DBN1 into field 138 to replace the old address, and set the status field 139 to ‘2’.

When the second data is pushed to the processor core 23, and when a branch instruction after the data load instruction has its branch decision to be ‘take the branch’, the system starts perfecting the next data into the DRB for the push of the next execution of the same load data instruction. For the state field 139 is ‘2’ at this time, the system no longer waits for the processor core 23 to calculate the data address. Instead, it directly outputs the DBN1 address in the field 138 in the row of the stride table 150 corresponding to the load data instruction and the branch stride selected by the branch decision (e.g., 140), and adds them in the adder 173. The system also makes a boundary check on the output 181 of 173. If the 181 does not exceed the boundary of the L1 data cache block, the selector 192 selects 181 to access the L1 data cache memory 162, and reads out the data to store in the corresponding entry in the DRB for push. And the address on 181 is stored as DBN1 in the corresponding row in the stride table. If 181 exceeds the boundary of the L1 data cache block but does not exceed the adjacent L1 cache block boundary, then use the 181 to address the DTT1 166, read the DBN1X address 132 of the next L1 data block (or the DBN1X address 130 of the previous data block) to output via bus 191, the DBN1X address is selected by the selector 192 and combined with the DBNY address 13 on 181 to access the memory 162, and read the data to store into the corresponding entry in DRB for push. And store the above-mentioned combined address DBN1 in the field 138 of the corresponding row in the stride table 150. In both cases, the status field 139 in 150 remains unchanged for ‘2’. If the address 132 of the output of 166 is in the BN2X format, the system will use the BN2X address to access the DAL2 168 via the bus 181. If the entry of 168 is valid, then use the BN1X address in the entry of 168 via bus 184 to write back the 166 to replace the BN2X address. If the entry of 168 is ‘invalid’, then use the address on 191 to address the L2 data cache memory 161 to read the L1 data block to store into the L1 data cache memory 162 and into the L1 cache block pointed to by the L1 cache block address 68 given by the L1 cache replacement logic. The 68 is also stored in the entry of DAL2 168 addressed by the 191, and is also stored in the DTT1 166 to replace the BN2X address.

If the 181 is out of the above boundary but does not exceed the L2 cache block boundary, the system uses the DBN1 address 138 to address the DCT1 176, and map the DBN1 address to DBN2 address and output it via the bus 182. The adder 172 adds the DBN2 addresses on 182 with the stride 140,and use the output of the adder to address the DAL2 168. If the entry is valid, then combine the DBN1X address in the entry and the DBNY 13 on 183, and use the combined address to access the L1 data cache memory 162 via bus 184, and read the data to store into the entry in DRB for push; and store the DBN1 address on 184 into the field 138 of the corresponding row of the stride table 150, and remain the field 139 to be ‘2’ unchanged. If the entry of the DAL2 168 is invalid, then use the 183 to address the L2 data cache memory 161 to read the L1 data block and store it into L1 cache memory 162 and into the L1 cache data block pointed to by the L1 data block number 68 given by the L1 data cache replacement logic. The system also combines the 68 and the DBNY on 183 to be the DBN1 address to access 162, and read the data to store into the DRB entry for push; and the DBN1 address is stored into the field 138 of the corresponding row of the stride table 150, and remain the field 139 to be ‘2’ unchanged.

If the 181 is out of the L2 cache block boundary but does not exceed the L3 cache block boundary, the system uses the DBN2 address on bus 182 to address the DCT2 175, and map the DBN2 address to DBN3 address and output it via the bus 186. The adder 171 adds the DBN3 addresses on 186 with the stride 140,and use the output 188 of the adder to address the DAL3 167. If the entry is valid, then combine the DBN2X address in the entry and the DBNY 13 on 188, and use the combined address to access the DAL2 168 via bus 189. If the entry of 168 is ‘valid’, then directly combine the DBN1X address with the DBNY 13 on bus 188 to be the DBN1 address, and use it to access the L1 data cache memory 162 via bus 184, and read the data to store into the entry in DRB for push; and store the DBN1 address on 184 into the field 138 of the corresponding row of the stride table 150, and remain the field 139 to be ‘2’ unchanged. If the entry of the 168 is invalid, then use the DBN2 address on bus 189 to address the L2 data cache memory 161 to read out the L1 data block, and store it into the L1 data cache memory 162 and into the L1 cache block pointed to by the L1 data cache number 68 given by the L1 data cache replacement logic; and the 68 is also stored into the entry of 168 which is addressed by the bus 189, and the entry is set to ‘valid’. The system also combines the 68 and the DBNY on 189 to be the DBN1 address to access 162, and read the data to store into the DRB entry for push; and the DBN1 address is stored into the field 138 of the corresponding row of the stride table 150, and remain the field 139 to be ‘2’ unchanged.

If the 181 is out of the L3 cache block boundary but does not exceed the L4 cache block boundary, the system uses the DBN3 address on bus 186 to address the DCT3 174, and map the DBN3 address to DBN4 address and output it via the bus 186. The adder 170 adds the DBN4 addresses on 196 with the stride 140, and use the output 197 of the adder to address the DAL4 120. If the entry is valid, then combine the DBN3X address in the entry and the DBNY 13 on 197, and use the combined address 197 to access the DAL4 120. If the entry of 120 is ‘valid’, then combine the DBN3X address with the DBNY 13 on bus 197, and use the combination to access the DAL3 167 via bus 125. If the entry of 167 is ‘valid’, then directly combine the DBN2X address in the entry with the DBNY 13 on bus 125 to be the DBN2 address to access the DAL2 168 via bus 189. If the entry of 167 is ‘invalid’, then use the DBN2 address on bus 189 to address the L2 data cache memory 161 to read out the L1 data block, and store it into the L1 data cache memory 162 and into the L1 cache block pointed to by the L1 data cache number 68 given by the L1 data cache replacement logic; and the 68 is also stored into the entry of 168 which is addressed by the bus 189, and the entry is set to ‘valid’. The operations that the system uses the DBN2 address on bus 189 to access the DAL2 168 and following are the same with the description of the previous paragraph. Finally, the system uses the DBN1 address to access 162, and read the data to store into the DRB 163 entry for push; and the DBN1 address is stored into the field 138 of the corresponding row of the stride table 150, and remain the field 139 to be ‘2’ unchanged.

If the 181 exceeds the L4 cache block boundary, the system uses the BN4 address on bus 196 to address the tag unit of 51 to read the corresponding tag 61 and sends it to the adder 169. 169 adds the tag 61 with the stride 140, and its sum 198 is selected by the selector 54 and then sent to the label unit in the 51 to match. If the matching generates a new BN4 address, then use that new BN4 address to address the AL4 120 via bus 123. If the entry is ‘valid’ in 120, then use the DBN3X address in the entry to address the DAL3 167 via bus 125. The subsequent operation that addressing 167 via the bus 125 is the same as that of the previous paragraph. If the entry of 120 is ‘invalid’, then use the new BN4 address on bus 123 to address the memory 122 to read out the L3 data block and store it into the L3 data cache memory 160, and the operations are as described above. If there is no match in the tag unit, then put the address from bus 198 to bus 113 to address the memory 111 to read out the L4 data block and store it into L4 cache memory 122. The process has been described above in this exemplary embodiment and will not be repeated. Finally, the system uses the DBN1 address, which is obtained by the mapping of each level of active list, to access 162, and read the data to store into the DRB entry for push; and the DBN1 address is stored into the field 138 of the corresponding row of the stride table 150, and remain the field 139 to be ‘2’ unchanged. If in the process the corresponding data block in a memory hierarchy level does not exist, the system will automatically read the data block from the lower memory level into the cache block specified by the cache replacement logic in the present hierarchy. The cache block address is also stored into the lower level active list, and the lower level cache block number is stored in the correlation table to establish a two-way mapping relationship.

The above describes the push process for data loading. Data memory can be done in a similar way, or by conventional methods such as storing into write buffers and when the data cache is idle, the data in the write buffer is written back to the data cache. When using the stride in the stride table 150 to guess and load the data (that is, when the field 139 is ‘2’ in 150), it is necessary for the processor core to send the correct data address via the bus 49 to compare with the guessed DBN1 address. If they are different, it is necessary to discard the data of the loaded data and its subsequent execution result, load the data with the correct data address on the bus 49, and set the corresponding field 139 to ‘0’ and recalculate the stride to store into 150. If there is a write buffer, then the loaded guessed address is also need to be compared with the address in the write buffer to make sure that the loaded data is the updated data. The DBN address can be mapped to a data address to be compared with the data address on 49. Also, it can map the address on 49 to the DBN address to compare with the DBN address that is generated by the system guessing. In addition, if the valid bits of the stride determined by the branch decision (such as 141) are “invalid” in the stride table 150, it also needs to generate the stride under that branch decision as described above.

The lowest level cache of the data cache hierarchy in the exemplary embodiment of FIG. 18 has the way-set associative organization, which has a tag unit and may has a TLB to convert virtual and real addresses; the level may be addressed by tag mapping in 51, or directly addressed by the cache address BN4. The remaining levels of the data caches are all fully associated, addressed by the cache address DBN. Each DBN and BN4 are mapped by the active lists and the correlation tables. Wherein the role of the active list is to map the lower-level cache address to a high-level cache address; the role of the correlation table is to map the higher-level cache address to a low-level cache address. Refer to FIG. 19 for its mechanism of action.

FIG. 19 is a schematic diagram showing the mechanism of the data cache hierarchy structure of the embodiment of FIG. 18. In FIG. 19, 200 is an L4 cache block containing two L3 cache blocks 201 and 202. Each L3 cache block contains two L2 cache blocks, such as 201 containing L2 cache blocks 203 and 204. Each L2 cache block also contains two L1 cache blocks, such as 203 contains L1 cache blocks 205 and 206. Assuming that the DBN1 address in the field 138 in the current stride table 150 points to the L1 cache block 205, then the system obtains the next L1 data cache address of the same data load instruction with the minimum mapping step and the least delay in accordance with the length of the stride 140, in order to access the L1 data cache memory 162 to read out the data to store into the corresponding entry in DRB.

The following description will be made with reference to FIGS. 18 and 19. Assuming that the address 138 that points to 205 is added to 140 and its sum does not exceed the boundary of 205, then directly use the sum 181 to be the new L1 data cache address to address the L1 cache memory 162 to read out the data and store it into the corresponding entry in DRB 163. If the sum 181 of the address 138 and 140 exceeds the boundary of 205 but does not exceed the boundary of the L2 cache block 203, the 138 address needs to be mapped from the BN1 format (through the L1 correlation table 176 in FIG. 18) to BN2 Format 182. The adder 172 adds the address 182 with the stride 140, and uses the sum 183 to address the entry of the AL2 168 that corresponds to the L2 cache block 203, and reads the DBN1X address of the L1 cache block 206, which is combined with the DBNY 13 on 183 to be the DBN1 address. The DBN1 address is used to address the L1 data cache memory 162 and is also stored into the field 138 of 150. If the entry of DTT1 166 that corresponds to the cache block 205 stores the address of the next cache block 206, the it can directly use the 181 (ignoring the carry overflow bit of 181) to address 166 to obtain the address of 206.

If the sum 181 exceeds the boundary of the L2 cache block 203, the DBN1 format of the 138 address needs to be mapped to the DBN2 format 182 via the DCT1 176, and the DBN2 format is mapped to the DBN3 format by the DCT2 175. The DBN3 format address is then added with 140, and the sum 174 is used to address the DAL3 167 to get the corresponding entry of the L3 cache block 201, to read the DBN2 address 189 of the L2 cache block 204. Then use the 189 to address the DAL2 168 to get the address DBN1 of the L1 cache block 207. Then it can use that address to address the L1 cache memory 162 via bus 184 to read data to store into DRB 163, and store that address into field 138 of 150. If the sum 181 exceeds the boundary of the L3 cache block 201, then map the DBN1 address in 138 to DBN2 format address via 176, and map it to DBN3 format via 175, and map it to BN4 format via 174; then use that BN4 address to access AL4 120 to obtain the DBN3 format address 125; use that DBN3 address to access DAL3 167 to obtain the DBN2 address 189; use that DBN2 address to access DAL2 168, to obtain the address DBN1 of the L1 cache block 207. Then it can use that address to access L1 cache memory 162 via bus 184 to read out the data to store into DRB 163 and store that address into the field 138 of 150.

The cache blocks at each level in the data cache hierarchy in the embodiment of FIGS. 18 and 19 form a tree structure. The L4 cache block is the root of the tree, and the cache blocks of other levels are different levels of branches of the root; other levels of cache blocks are also the roots of their higher-level cache blocks. The roots and the branches, and the branches and branches are connected by two-way address mapping to form the tree. Beginning from a L1 branch (L1 cache block) it can reach any following L1 branches of the same root (the same L4 cache block) by mapping. Only when the target is beyond the scope of the root, it needs to be matched by the tag unit in 51. If the target branch and the source branch belong to a same sub-root, then it needs less mapping levels. If the target branch and the source branch belong to different sub-roots, then it needs more mapping levels. The embodiment of FIG. 18 can be modified to reduce the mapping levels.

Please refer to FIG. 20, which is an improved embodiment of the data cache hierarchy in the embodiment of FIG. 18. In FIG. 20, the L3 data cache memory 160, the L2 data cache memory 161, the L1 data cache memory 163, the data read buffer 163; the stride table 150; the DTT3 164, the DTT2 165, the DTT1 166; the DAL3 167, the DAL2 168; the adders 172, 173; the DCT3 174, the DCT2 175; and the selector 192 have the same function with the modules with the same numbers in the right half of the FIG. 18. The DCT1 176 format is shown as 209. Which not only stores the L2 data cache block DBN2X of the L1 cache block, but also stores its corresponding L3 data cache block number DBN3X and L4 cache block number DB4X.

The operation is similar to that of the embodiment of FIG. 18, which outputs the DBN1 address in the field 138 of the row corresponding to the data load instruction of stride table 150, and outputs the stride (such as 140) selected by the branch decision, and adds them in the adder 173. The system then check the boundary for the output 181 of the 173. If the boundary is within the L1 cache block, then directly use the 181 to address the L1 data cache memory 162. If it exceeds the L1 cache block, then use the address on 138 to address the row 209 of DCT1 176, according to the above boundary judgment to select a cache address of a level in 209, and add that address with the stride 140 by adder 172, and the sum is 183. If it is within the boundary of L2 cache block, then select the DBN2X in 209 to add with 140, and the sum 183 is sent to address the DAL2 168; if it is within the boundary of L3 cache block, then select the DBN3X in 209 to add with 140, and the sum 183 is sent to address the DAL3 167; if it is within the boundary of L4 cache block, then select the DBN4X in 209 to add with 140, and the sum 183 is sent to address the AL4 120. The remaining operations are the same with that of the embodiment of FIG. 18, and are not described again. The embodiment of the FIG. 20 can reduce the reverse mapping step and delay from the branch to the root. Also, an adder can be used to add the combined address (the combination of the BN4X in 209 and the DBNY 13 in 138) with 140, and the sum is used to address the tag unit in 51 to map the BN address to data address, in order to be compared with the correct data address on bus 49.

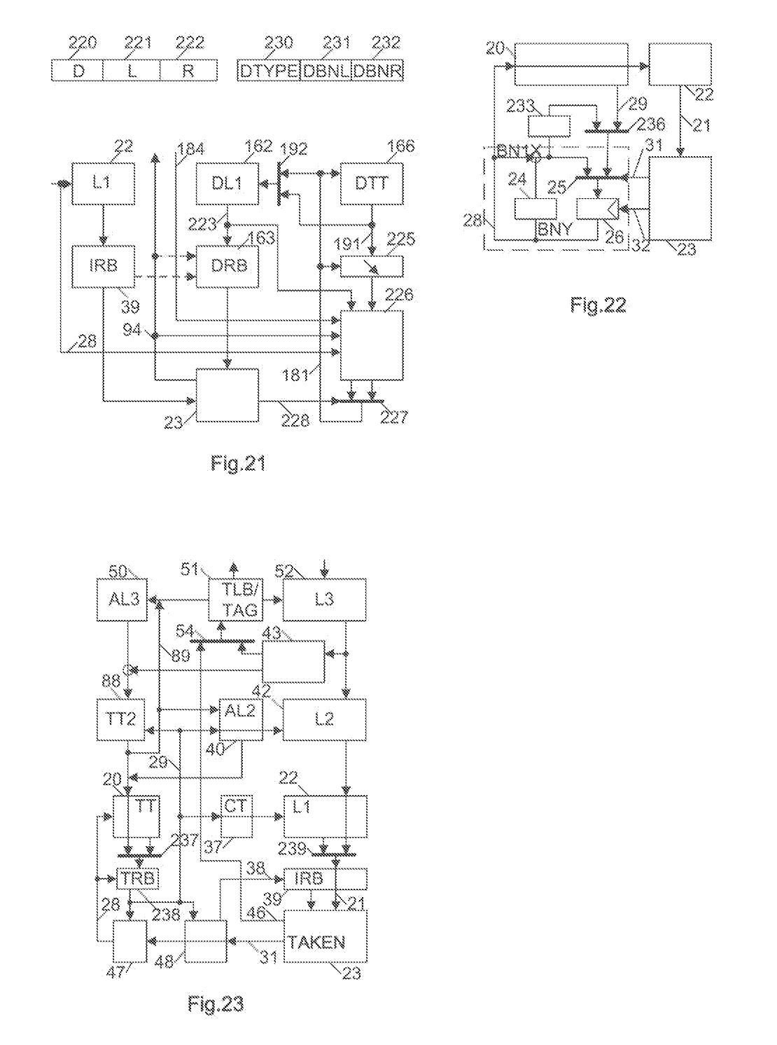

Please refer to FIG. 21, which is an exemplary embodiment of perfecting data organized in a logical relationship. Data can contain address pointers, that is, organized by logical relationships. In this embodiment, perfecting of the data organized as the binary tree is used as example, and the perfecting of the data organized by other logic form is similar. 220-222 are the data in the memory, where 220 is the data, 221 is the address pointer of the left branch of the binary tree, and 222 is the address pointer of the right branch of the binary tree. The data cache memory 162, the data read buffer 163, the data track table 166, the selector 192, the instruction memory 22, the IRB 39, and the processor core 23 in FIG. 21 have the same functions as the modules of the same numbers in FIG. 18. Some of the modules not shown in FIG. 21 have the same functions as the modules of the same numbers in the embodiment of FIG. 18. A shifter 225, a learning engine 226, and a selector 227 are added. The comparison result 228 is outputted from the processor core 23. In this embodiment, the entries in the data track table (DTT) 166 one-to-one correspond to the respective data entries of the data memory (DL1) 162.

The learning engine 226 is responsible for generating entries for the data track table (DTT). 230-232 is an entry in DTT 166 corresponding to data 220-222 of 162. Each entry in 166 has a ‘valid bit’, where the data type entry 230 corresponds to the data entry 220, and the pointer entries 231 and 232 respectively contain the address pointers in 221 and 222 in the DBN format. Data type entries, and pointer entries each has their identifiers to distinguish them. The DBN format can address the data memory 162 directly.

The data read pointer 181 controls to read a row of track from the data track table 166. If the DBNY value in the pointer is close to the end of a row, then it according to the BN address at the end track point of that row, reads out the next row of the address order, and sends them to the shifter 225. In 225, that one row of track or two rows of tracks are shifted left, in the amount of the DBNY value in the data read pointer 181. The learning engine 226 receives the shifted plurality of entries, determines the data type entry 230 according to the identifiers in these entries. 226 also determines the operation to the pointer entries 231 and 232 according to the data type in the data type entry 230. The comparison result 228 generated by the processor core 23 controls the selector 227 to select one out of a plurality of pointers output from 226 to put onto the data read pointer 181 to address the data memory (DL1) 162 to serve data to the processor core 23.

For example, the data value in the entry 220 in the data memory 162 is ‘6’, the entry 221 contains the 32-bit address and the entry 222 contains the 32-bit address ‘R’. Correspondingly the data type in entry 230 of the data track table 166 is the binary tree, and the control signal is the comparison result 228 generated by the processor core 23 executing the instruction of the address ‘YYY’; the 231 contains the DBN format address pointer ‘DBNL’ obtained by address mapping of the address pointer in 221; the 232 contains the DBN format address pointer ‘DBNR’ obtained by address mapping of the ‘R’ address pointer in 222. The learning engine 226 checks the plurality of entries from the shifter 225 and selects the data type entries 230 based o the identifiers. According to the binary tree data type in 230, the 226 outputs the entries 231 and 232 from the shifter 225 to the two inputs of the selector 227. Assuming that the instruction with the instruction address ‘YYY’ compares the value to be searched ‘8’ with the value ‘6’ of 220 loaded from (DL1) 162 into 23, and the result of comparison is ‘1’, which means that the searched value is greater than the value in the current node 220. 226 observes the address 28 that controls the L1 memory 22, when it reaches ‘YYY’, it makes the comparison result 228 from the processor core to control the selector 227. 228 at this time controls the 227 to select the right branch pointer ‘DBNR’ in the 232 to be outputted to the data read pointer 181. If the valid bit in 232 is ‘valid’, then the data pointed to by the right branch pointer in 232 becomes the new current data. The selector 192 selects the 181 to address the DL1 162 to output the new current data to store into DRB 163. The 181 also addresses DTT 166, making 166 to output the corresponding data track that contains the new current data to the shifter 225. The block offset part DBNY in the address on 181 controls the shifter 225 to shift the data track to the left, make the data type, the DBNL address, the DBNR address (as in the formats of 230, 231, 232) align to the input of the learning engine 226.

Each entry of DRB 163 corresponds to a block offset address (DBNY), and the 162 (DL1) stores the entire data block into 163 (if the data specified by data type 230, such as 220-222, exceeds one data block, then move the data beginning from the ‘DBNR’ address to the next data block in address order). The processor core 23 uses the offset part of the data address 94 generated by executing the load instruction to address the DRB 163, reads the current data and its left branch address pointer and the right branch address pointer (format of 220, 221, 222). The processor core 23 executes the instruction, compares the searching value ‘8’ with the current data, and generates the comparison result 228.

The learning engine 226 monitors the address 28, the comparison result 228 generated by the processor core 23, the data address 94, and the corresponding data 223 output by the (DL1) 162 to generate a data track entry to store into the DTT 166. When the entry in the corresponding 166 is ‘invalid’ (not established), the data cache system sends the data address 94 generated by the processor core 23 to the tag unit 51 (not shown in the figure), etc., to be matched and mapped to the DBN address 184. 184 addresses the data memory 162, reading the data to send to the processor core 23 via 223. The learning engine 226 records the address on 94, and the data on the 223 output from the entry in the data memory 162 addressed by that address. 226 also compares the newly generated data address 94 with the previously recorded data on 223, and if they are the same, Then the learning engine 226 matches and maps the newly generated data address 94 to the DBN, and stores the DBN into entries of DTT 166 and sets these entries to be ‘valid’. The DTT entries are those corresponds to the data entries read our on bus 323. That is, store the ‘DBNL’ obtained by matching and mapping the address pointer in 221 into the 231, and store the ‘DBNR’ obtained by matching and mapping the address pointer ‘R’ in 222 into the 232. Alternatively, 226 may also record and compare the mapped BN format data and address.

226 determines that the data memory 162 entry that satisfies the following conditions is a ‘data’ (non-pointer) entry. The conditions are that the data address of the entry itself is only one or a few of the data lengths to the entry containing the address pointer, and that the data on 223 is never the same as the subsequent addresses on 94 in a plurality of instruction loops. The range of the instruction loop may be determined by the reverse branch instruction address and its branch target instruction address in IRB 39. The entry of DTT 166 corresponding to the ‘data’ entry in the data memory 162 is the data type entry. The learning engine stores the pattern leavened by monitoring (that when the address 28 is ‘YYY’, selecting the BN address in 231 if the 228 is ‘0’, and selecting the BN address in 232 if the 228 is ‘1’) into the data track table entry (230 here) corresponding to the ‘data’ (220 here), and sets that entry to be ‘valid’. The valid bits in the data type entry may be a plurality of bits, if it is greater than a preset value then it is ‘valid’, and if it is not greater than that preset value then it is ‘invalid’.

After the data track table entry is established, processor core 23 executes the instruction to generate the comparison result 228 which controls the selector 227 to select the address pointer, moving the data read pointer 181 along the binary tree. When a new data point is reached, according to its data type (e.g., 230), the learning engine 226 controls to read out the data and its address pointers (e.g., 220-222) of the same group from the data cache 162 and stores them in the DRB 163, ready to be read by the data address 94 generated by the processor core 23. This process prevents the delay caused by the data address 94 matching in the tag unit and the address the data memory 162 access. The access latency of DRB 163 is a single clock cycle, typically less than the access latency of 162.

Further, the data read buffer may be organized as in the embodiment of FIG. 18, i.e., the entry of 163 corresponds to the entry of the IRB 39 one-to-one. A field is also added to each entry in the data track table (DTT) 166 in this organization mode for recording the address or tag (such as the sequential number of the load instruction in the instruction loop, or the BNY address of the instruction) of the instruction that reads the data in the data memory 162 corresponding to the entry. When the learning engine 226 controls to read the data in 162 according to the entry in 166, it stores the data into the entry of DRB 163 that corresponds to the above tag. When a load instruction in IRB 39 is pushed into the processor core for execution, the data in the DRB entry corresponding to the IRB entry of that instruction is also pushed to the processor core 23. Thus, removing the load delay.

The learning engine 226 performs a learning. The result of the learning is stored in the data track table 166 in the form of data types and address pointers. The data type read from the data track table is used to control the processing of the other entries read by the 226 itself from the data track, such as moving an entry of the input 226 to a particular 226 output, or controlling the polarity of the comparison result 228, to make the selector 227 selects the correct address pointer under the control of 228 to place into the data read pointer 181, and to address the data memory 162 to output data (e.g., 220). The data type also controls 226 to generate and output a single or a plurality of subsequent addresses (adding an increment to the correct pointer address, where increment is an integer multiple of the data word length), and to address the 162 to output other data of the same group (such as 221,222). Therefore, the data type is the control setting for the 226, for example, the IRB address or tag when the comparison result 228 is generated, the polarity of the 228, the number of the subsequent addresses that need to be generated. The learning engine 226 also compares the DBN address of the bus 181 with the DBN 184 matched and mapped from the data address 94 generated by the processor core 23. If they are different, then reduce ‘1’ to the valid value in the corresponding data type entry in the DTT 166, and put the DBN 184 obtained by mapping on the bus 181 to address the data memory 162 to read the correct data, and also address the DTT 166 to read the corresponding track table entry. The learning engine 226 relearns the 166 entries whose valid value is reduced to ‘0’.

The exemplary embodiment of FIG. 21 may be used in conjunction with the embodiment of FIG. 18. The learning engine 226 continuously monitors the data type in the data track table and also monitors the data on the data memory output 223 and the data address 94 output by the processor core 23. If the data on 223 is not the same as the address on the subsequent 94, the valid value is decremented by ‘1’ in the data type entry in the DTT 166 corresponding to the data memory 162 entry that outputs the data. If the data on 223 is the same as the address on subsequent 94, the valid value of the data type entry is incremented by ‘1’. The system operates on the same fro up of data that corresponds to a data type entry whose valid values is greater than one preset value as shown in the embodiment of FIG. 21, that is, assuming that the data contains a data pointer. The system operates on the data where the valid value is not greater than the pre-set value in the manner shown in the embodiment of FIG. 18, that is, assuming that the data does not contain an address pointer, and use the ‘stride’ to calculate the DBN address to read the data in the data memory 162 to store into the DRB 163 for the use of the processor core 23. Each time the address on 181 generated as in the embodiment of FIG. 21 is the same with the address on 94, then increase ‘1’ to the valid value; if they are different, decrease ‘1’ to the valid value. This is a reward for the learning engine 226. The data type entry 230 may further include a field which records the group of data is operated in accordance with the embodiment of FIG. 18, or the embodiment of FIG. 21, or otherwise.

FIG. 22 is an exemplary embodiment to process function call and a function return instructions. The L1 cache 22, the processor core 23, the track table 20, the incrementer 24, the selector 25, and the register 26 included in FIG. 22 have the same functions as the modules of the same numbers in the embodiment of FIG. 2. A stack 233 and a selector 236 is added. When the scanner extracts the instruction type format, it decodes the instruction to check whether it is a call or return instruction, and record it in the instruction type format field 11 (see FIG. 1) in the track table entry. When the instruction type on the track table output 29 in FIG. 22 is a call instruction and the TAKEN signal 31 is ‘branch success’, the controller (not shown) controls to push the BNX in the register 26 and the BNY outputted from the incrementer 24 into the stack 233. When the instruction type on the track table output 29 is a return instruction, the controller controls the selector 236 to select the output of the stack 233. When 31 is ‘branch success’, it pops the BN from the top of the stack 233 into register 26, causing the program to return to the following instruction of the function call instruction.

The instruction type (field 11) of the indirect branch instruction can also be subdivided to provide guidance to the cache system. There is a class of indirect branch instructions that jump to the same instruction address each time they are executed, or the instruction address generated each time is incremented by a ‘stride’ on the instruction address generated by the last execution. This type of indirect branch instructions is recorded in the track table entry 11 to be ‘duplicated’, and the stride table 150 in FIG. 17 is used to record the generated instruction address and the stride. The BNX and BNY instruction addresses can also be stored in the fields 12 and 13 of the track table entry (see the embodiment of FIG. 1) and the stride table is only used to record the stride length. The specific operation is the same as the data address generation method shown in the embodiments of FIGS. 17 and 18, and is not described here. Since the cache system of this disclosure can actively provide non-branch instructions and direct branch instructions to the processor core and the generation of the indirect branch target addresses is based on the contents of the registers or memory, the processor core using the cache system of this disclosure does not need to reserve the program counter that generates the instruction address. The program debug hardware breakpoint can be mapped to the BN format address, which can be compared to the BN of the tracker and trigger the interruption when they are the same. Accordingly, the processor core does not need to have the pipeline stages that are relevant to instruction fetching.

Refer to FIG. 23, which is another exemplary embodiment of the processor system of the present invention. FIG. 23 is an improvement of the embodiment of FIG. 8 in which the AL3 50, the level 3 cache TLB/tag unit 51, the L3 cache memory 52, the selector 54, the L2 track table 88, the AL2 40, The L2 cache memory 42, the track table 20, the L1 cache correlation table 37, the L1 cache memory 22, the instruction read buffer 39, the tracker 47, the tracker 48, the processor core 23 have the same functions with the modules of the same numbers of the embodiment of FIG. 8. The track read buffer (TRB) 238, and selectors 237, 239 are added.

TRB 238 stores the tracks corresponding to the instruction blocks stored in IRB 39. The processor core 23 has two front-end pipelines, which are FT (Fall Through) and TG (Target). The tracker 0 (TR0) 48 provide the BNY increment 38 to control the IRB 39 to provide the FT pipeline of the processor core 23 with the sequential instruction stream, and the tracker 1 (TR1) 47 read the TG address along the track in TRB in advance. The TG address of the BN1 format addresses the L1 instruction memory 22, and the TG address of the BN2 format addresses the L2 instruction memory 42, each of which reads the TG instruction. The selector 239 selects one of the TG instruction to send to the TG pipeline of the core, based on by program sequence whether BN1 or BN2 format should be used. The system controls the selector 239 to select one TG instruction to send to the TG pipeline. The Taken signal 31 selects the output of the FT or TG front-end pipeline to send to the back-end pipeline to complete the execution. When the branch is successful, the TG instruction block corresponding to the branch instruction from L2 or L1 is selected by the selector 239 to be stored in the IRB 39. The track corresponding to the TG instruction block, and from the L2 track table (TT2) 88 or the track table (TT) 20 is also selected by the selector 237 to be stored into the TRB 238 for the TR1 47 to read. If the TG instruction block is read from the L2 instruction memory 42 by the BN2X address on the track, it is also stored into the L1 instruction memory 22 and into the L1 memory block pointed to by the BN1X given by the replacement logic. The BN1X is also stored in the entry in the AL2 40 pointed to by the BN2X. The BN3 format address on the track output from the L2 track table 88 is sent to the AL3 50 via bus 89 to be mapped to BN2 address (or when the AL3 entry is invalid, it addresses L3 52, reads the instruction block to store in an L2 memory block in 42, whose block address is BNX2). The BN2 address replaces the original BN3 address on the track.

By the same principle, the BN2 format address on the track output from TT2 88 or TT 20 or the track in the 238 TRB can be mapped to BN1 format by AL2 40 (or address L2 42 to store in 22 L1 to obtain BN1 address). In the present embodiment, the 88 TT2 stores TG address of the BN3 or BN2 format, and 20 TT stores only the addresses of the BN2 or BN1 format, and the 238 TRB allows the TG addresses of the BN3, BN2, or BN1 formats. The limit of BN address in TT2 and TT triggers the instruction moving from the low-level memory to the high-level memory, avoiding the traditional cache mechanism that the cache filling is triggered by the cache missing, and avoiding the inevitable missing in the traditional mechanism. And it also ensures that the branch target instruction is at the same cache level or the adjacent lower cache level as the direct branch instruction. Since the 47 TR1 reads the TG address on the track in advance, it can partially or completely hide the access delay of 42 L2, or 22 L1. If an instruction block has branch instructions right next to one another, it's corresponding track can be deliberately assigned with TG addresses in interleaving BN1 and BN2 formats so to hide the access delay of the 42 and 22 as much as possible. If the address read on the TRB is in the BN3 format, and if the corresponding branch is successful (take), the processor core 23 needs to wait for the BN2 address mapped from that BN3 address (the mapping process begins when the track is outputted from the 88 TT2, so that it can partially or completely hide the latency of AL3 or L3) to fill in the track in TRB 238, and after that, it can execute the branch target instructions. If the corresponding branch is unsuccessful (not take), the processor core 23 does not wait and directly execute the fall-through instruction, and the mapped BN2 format is filled into the track after it is obtained. After all of the BN3 format addresses on the track in the TRB 238 are replaced with the BN2 formats, the track is filled into the row indicated by BN1X provided by the above replacement logic in TT 20. In the present embodiment, the system may control the L2 instruction memory 42 or the L1 instruction memory 22 to provide TG instruction to the processor core according to the track outputted from the TT2 88 or the TT 20, while the IRB 39 provides fall through instructions for the processor core. In the present embodiment, the process of executing the next instruction block is treated as a branch, and the instruction type in the end track point (track entry) in the track is set as an unconditional branch, so that the processing is the same as the above branch processing. The methods and systems in this embodiment may also be suitable to other multi-level instruction track cache memory systems, as shown in FIGS. 11, 12, 13, 18.

Back to the FIG. 12, the two application forms of the structure of the embodiment shown in FIG. 12 may have more embodiments. For example, the functional modules in FIG. 12 can be located in the two sides of a communication channel with long delay. Assuming that the memory 111 in FIG. 12 is located at one end of the communication channel and the remaining modules are located at the other end of the communication channel. The communication channel may be between the memory of one processor core and another processor core on the same chip; or between the core of one processor lane and the memory of another processor lane on the same chip; or between the processor core of one chip and the memory of another chip; or between the processor of one computer and the memory of another computer; or between a processor core or computer with the memory on the other end of the wired or wireless network; or other long-delayed communication channels.

The following description uses the network channel as an example. The IPv6 address is 128 bits. Assuming that the memory address is 64 bits, and the IPv6 address and memory address are combined into a 192-bit address to address the remote memory on the other end of the network. In order to support the 192-bit address, only the components 43, 51, and 113 in FIG. 12 need to meet the bandwidth of 192 bits, while their functions and operations remain the same. All other components do not need any change for this bandwidth of 192 bits. Specifically, the TLB/TAG unit 51 need to be able to store the tag of 192-bit address (for example, a 128-bit tag plus a 64-bit memory tag), and the scanner 43 also needs to add the 192-bit current instruction block address provided by the 51 and the branch instruction block offset, and the branch offset together to obtain the 192-bit branch target address. The 192-bit branch target address is matched with the TAG content of the tag unit in 51. If it does not match, the 192-bit branch target address is sent via bus 113 to the memory 111 at the other end of the channel to fetch the instructions. If it is matched, the BN3 or BN2 address is stored in the L2 track table 88 as described above in the embodiment of FIG. 12. Other channels such as LANs, or connections between the processor core and memory of different computers can be supported in the same way, by adding the network address of the function unit such as the computers and memory as the prefix in front of the memory address. The memory 112 and the memory 111 in the embodiment of FIG. 12 may also be placed on the other end of the communication channel.

The specific embodiment of the above-described application form of the structure of FIG. 12 can also be applied to the structures of FIGS. 13 and 18. Use the FIG. 18 as an example, assuming that the memory 111 in FIG. 18 is located at one end of the communication channel and the remaining modules are located at the other end of the communication channel. Then it only needs the TLB/TAG unit 51, the scanner 43, and the bus 113 to support the memory address width with the network address prefix as described in the above embodiment, then it can support the operation that the instruction memory is in the remote end of the communication channel. The specific embodiment of FIG. 13 is the same as that of the instruction memory part of FIG. 18 described above, and will not be described again. In FIG. 18, if data is also stored in the memory 111 and the memory 112, the bandwidth of the adder 169 and the output bus 198 in which the data address is generated also need to support the memory address with the network address prefix as described above. In addition to the bandwidth of the above 51, 43, 169 modules and buses 113, 198, the remaining modules in FIG. 18 need not do any change since the remaining modules are operated based on the cache addresses. The network memory address (network address+memory address) is mapped to the cache address via the tag unit TAG in 51. The width of the cache address depends on the organization of the cache, regardless of the network memory address.

When the memory 111 and the other modules in FIG. 18 are at different ends of the network, the address on the bus 113 may be transmitted by packet, and the network address in the network memory address may be placed at the header of the packet, and the memory address of the network memory address can be placed in the packet contents. When the memory 111 can be accessed by a plurality of processor cores or computers, an arbiter should be provided in 111 to determine the access order. In the processor core, the thread register stores the network address corresponding to each thread. The adder 169 or the adder in the scanner 43 in FIG. 18 may use a bit width that equals to the bit width of the network memory address, but the optimized implementation of its bit width may be as long as the memory address bit width is satisfied. At the same time when the adder obtains the memory address of the branch target or data, the system uses the thread number of the thread being executed to address the thread registers, and reads out the network address stored of the thread. The network address is combined with the calculated memory address, which is the network memory address, and which is sent to the tag unit TAG in 51 for matching.

Similarly, the tag unit in 51 can store multiple network memory addresses, for example each entry is 192-bit. But there are several ways to optimize. One is to use two tables, each entry in the table 2 stores the memory address tag and a row number of table 1, while the table 1 stores the network address. The network address of the network memory address firstly match with the content in table 1 to obtain the row number of table 2. The resulting row number of table 2 is combined with the memory address to be sent to the table 2 for matching. The matching result of the table 2 is the cache address. If no matching in table 2, then use the network memory address via bus 113 to fetch the instruction or data from the memory 111 to fill in the memory 112. The other method is to only use table 2, which stores the memory address tag and the row number of the above thread register (or thread number). At this time combine the row number of the thread register (or thread number) with the memory address to send to the table 2 for matching. If no matching in table 2, then use the thread register row number (or thread number) to address the thread register to read out the network address, combine the network address with the memory address to obtain the network memory address, which is sent to the memory 111 via bus 111 to fetch data or instruction to fill into the memory 112. So that the actual cost that need to be increased is not much.

The scanner 43 in the embodiment of FIGS. 12, 13, and 18 calculates the branch target instruction address of the branch instruction based on the instruction block address of the branch instruction from the tag unit in 51. The tag unit in 51 stores the physical address, so that the branch target instruction address calculated by the scanner 43 is the physical address. The physical address of the branch target instruction can be directly matched with the contents of the tag unit in 51 without passing through the TLB mapping, as long as it does not cross the physical page boundary. Similarly, the data address generated by the adder 169 based on the physics address in the tag unit of 51 is also the physical address, and as long as it does not cross the physical page boundary, it can be directly matched with the contents of the tag unit in 51 without going through TLB mapping. The result of the matching is the BN address of the lowest level cache. In FIGS. 4, 5, 12, 13, 18, only the indirect branch instruction address on bus 46 is the virtual address, and it needs to be mapped to the physical address via the TLB in 51. The output of the scanner 43 and the data address generator 169 are all of the physical addresses that can be directly matched in the TAG in 51. And the other addresses that access the last-level cache are all cache address format BN, such as the bus 29 in FIGS. 4, 5, the bus 89 in FIGS. 8, 11, 12, and the bus 119 in FIGS. 13, 18, which can directly address the last level cache, the AL, CT, and the TAG in 51, without the need to go through the mapping of the TLB or TAG unit in 51.

While the embodiments of the present disclosure have described only the structural features and/or methodologies of the present disclosure, it should be understood that the claims of the disclosure are not limited to the described features and processes and that the various components listed in the above exemplary embodiments are for ease of description only and may include other components, or some components may be combined or omitted. The described components may be distributed in a plurality of systems physically or virtually, and can be implemented by hardware (such as the integrated circuits), software, or the combination of hardware and software.

No matter how the technology in the field develops and what development will be gained in the future, all the replacement, adjustment and improvements are within the scope of the appended claims.

1. A processor system comprising a cache and a processor core, wherein:
the serving cache autonomously serves (pushes) instruction to the processor core for execution based on the control flow information preserved in the cache and the branch decision provided by the core;
the processor core provides branch decision to the serving cache; and
the processor core provides instruction address to the serving cache only when it executes an indirect branch instruction.
